(19) United States
(12) Patent Application Publication
(10) Pub. No.: US 2009/0029093 A1
(43) Pub. Date: Jan. 29, 2009

(54) OPTICAL INFORMATION RECORDING MEDIUM AND PROCESS FOR PRODUCING THE SAME

(75) Inventor: Takashi Imai, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/118,269

(22) Filed: May 9, 2008

(30) Foreign Application Priority Data
May 9, 2007 (JP) 2007-124408

(51) Int. Cl. G11B 7/242; G11B 7/246

(52) U.S. Cl. 428/64.8; 428/64.4; 428/65.2

(57) ABSTRACT

An optical information recording medium includes, in order, a first substrate; a recording layer capable of recording and reproducing information by irradiation with a first laser; a reflective layer; at least two visible information recording layers capable of recording visible information by irradiation with a second laser; and a second substrate, wherein said two visible information recording layers are not fused or mixed with each other by irradiation with said second laser light.

### BACKGROUND OF THE INVENTION

1. Field of the Invention

The present invention relates to an optical information recording medium and, more particularly, to an optical information recording medium which has a digital information recording layer for recording musical data or the like and a visible information recording layer designed for recording a visible information for discriminating the recorded data. Also, the invention relates to a process for producing the optical information recording medium.

2. Description of the Related Art

With optical information recording media for recording a visible image by a laser on the label side thereof, decolorizable dyes (those dyes having a color before recording which are to be decomposed by light and/or heat upon recording to decolorize) have so far been used in the recording layer as described in JP-A-2005-250079 (the term “JP-A” as used herein means an “unexamined published Japanese patent application”) and, therefore, the recorded areas have been displayed as colorless areas.

On the other hand, in the image-recording method described in JP-A-2002-203321, the label side is irradiated with a laser light in a locus different from that for ordinary digital data recording, and hence, it has been difficult to form a high-contrast visible image with a dye having conventionally been used on the information (digital information) recording side of an optical disc. In addition, it is also described in the document to fuse or mix two light-sensitive or heat-sensitive layers with each other by irradiation with a laser light to thereby change visible light characteristics. However, nothing is described about what type of a heat-sensitive layer is to be used and about a plurality of color-forming recording layers.

Also, dyes to be used on the image display side are liable to fade upon storage and by exposure to light and, in addition, involve the problem that, with the lapse of time, the image suffers reduction of contrast, thus good visibility being unable to be maintained for a long time.

Further, in the method described in JP-T-2006-527097 (the term “JP-T” as used herein means a published Japanese translation of a PCT patent application), an isobenzofuranone-containing leuco dye on the label side forms color to thereby record an image. In this method, however, a multi-color image recording (color image) is unable, though a black mark or the like can be obtained, and nothing is described about a plurality of color-forming recording layers.

### SUMMARY OF THE INVENTION

The invention provides an optical information recording medium which can display image information or letter information on the label side thereof by forming color upon being irradiated with a laser light and which has a plurality of color-forming recording layers to permit recording of a multi-color visible image, and provides a process for producing the medium.

The invention has been completed by the following means.

<1> An optical information recording medium comprising, in order:

a first substrate;

a recording layer capable of recording and reproducing information by irradiation with a first laser;

a reflective layer;

at least two visible information recording layers capable of recording visible information by irradiation with a second laser; and

a second substrate,

wherein said two visible information recording layers are not fused or mixed with each other by irradiation with said second laser light.

<2> The optical information recording medium of <1>, wherein

at least one of said visible information recording layers contains a compound capable of forming a dye by at least light or heat.

<3> The optical information recording medium of <1>, wherein

at least one of said visible information recording layers contains a compound capable of undergoing at least color reduction or decoloration by at least light or heat.

<4> The optical information recording medium of <2>, wherein

said compound capable of forming the dye comprises a compound represented by the following formula (1) or formula (2):

AP¹-PDH1-AP² Formula (1)

wherein

PDH1 represents a group containing a moiety capable of causing a reaction accompanied by change in absorption upon leaving of AP¹ and AP², and

each of AP¹ and AP² represents a group capable of thermally leaving, a group capable of leaving or a hydrogen atom, provided that at least one of AP¹ and AP² is a group capable of thermally leaving,

PD²-AP³ Formula (2)

wherein

PD² represents a group containing a moiety capable of causing a reaction accompanied by change in absorption upon breakage of the bond with AP³, and

AP³ represents a group capable of thermally leaving.

<5> The optical information recording medium of <4>, wherein

said compound capable of forming the dye comprises a combination of said compound represented by formula (2) and a compound represented by the following formula (3), which has no absorption in a range of from 400 nm to 850 nm:

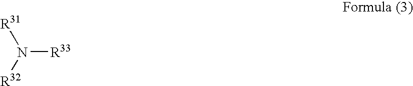

wherein

each of R³¹ and R³² represents a hydrogen atom or an aliphatic group, and

R³³ represents an aliphatic group, an aryl group, a hetero ring group, an acyl group, an aromatic oxycarbonyl group, an aliphatic sulfonyl group, an aromatic sulfonyl group, a phosphoryl group, a carbamoyl group or a sulfamoyl group,

provided that R³¹ to R³³ may be connected to each other to form a 5- to 7-membered, nitrogen-containing hetero ring.

<6> The optical information recording medium of <2>, wherein

said compound capable of forming the dye comprises a compound represented by the following formula (1-1):

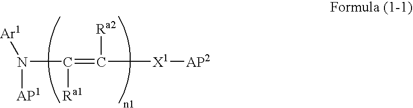

wherein

Ar¹ represents an aryl group or an aromatic hetero ring group,

X¹ represents —O— or —N(Ra³)—,

each of Ra¹, Ra², and Ra³ represents a hydrogen atom or a substituent,

n1 represents an integer of 0, 1 or 2, and

AP¹ and AP² are the same as the AP¹ and AP² of formula (1), respectively,

provided that Ar¹, Ra¹, Ra², and Ra³ may be connected to each other to form a 5- to 7-membered ring,

when n¹ represents 2, each Ra¹ may be the same as or different from the other Ra¹ and each Ra² may be the same as or different from the other Ra², and

when n¹ represents 0, X¹ represents —N(Ra³)—.

<7> The optical information recording medium of <2>, wherein

said compound capable of forming the dye comprises a compound represented by the following formula (2-1), (2-2) or (2-3), or a tautomer thereof:

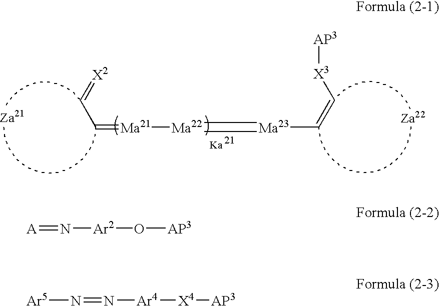

wherein

AP³ of each of formulae (2-1), (2-2) and (2-3) is the same as the AP³ of formula (2),

Za²¹ represents a group of atoms forming an acidic nucleus together with C—C═X²,

Za²² represents a group of atoms forming an acidic nucleus together with C—C—X³-AP³,

each of X² and X³ independently represents an oxygen atom, a sulfur atom or NR, provided that R represents a hydrogen atom or an alkyl group,

each of Ma²¹, Ma² and Ma³ independently represents a substituted or unsubstituted methine group,

Ka²¹ represents an integer of 0 to 2, provided that when Ka²¹ represents 2, each Ma²¹ may be the same as or different from the other Ma²¹ and each Ma² may be the same as or different from the other Ma²²,

Ar² represents an arylene group,

A represents a substituted aliphatic group, a carbon ring group or a hetero ring group,

Ar⁴ represents a divalent substituted aliphatic group, a divatent carbon ring group or a divalent hetero ring group,

Ar⁵ represents an aryl group or a hetero ring group, and

X⁴ represents a single bond or an oxygen atom.

<8> The optical information recording medium of <3>, wherein

said compound capable of undergoing at least color reduction or decoloration comprises at least one dye selected from the group consisting of an oxonol dye, a cyanine dye, an azo dye, a phthalocyane dye and a pyrromethene dye,

<9> The optical information recording medium of <8>, wherein

said oxonol dye comprises a dye represented by the following formula (2-1 D_{OX}):

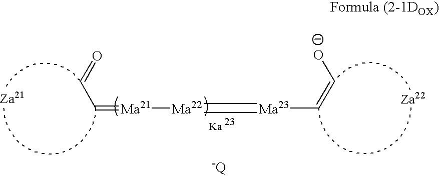

wherein

Q represents a monovalent cation necessary for neutralizing an electric charge of the dye,

Za²¹ represents a group of atoms forming an acidic nucleus together with C—C═O,

Za²² represents a group of atoms forming an acidic nucleus together with C═C—O⁻,

each of Ma²¹, Ma²² and Ma²³ independently represents a substituted or unsubstituted methine group, and

Ka²³ represents an integer of from 0 to 3,

provided that when Ka²³ represents 2 or 3, each Ma²¹ may be the sane as or different from every other Ma²¹ and each Ma²² may be the same as or different from every other Ma²².

<10> The optical information recording medium of <I>, further comprising, in order:

an adhesive layer; and a second reflective layer, both being between said reflective layer and said visible information recording layers.

<11> The optical information recording medium of <1>, further comprising:

an adhesive layer between said reflective layer and said visible information recording layers.

<12> The optical information recording medium of <1>, further comprising, in order:

a protective layer; and an adhesive layer, both being between said reflective layer and said visible information recording layers.

<13> The optical information recording medium of <1>, further comprising, in order:

a first protective layer; an adhesive layer; and a second protective layer, all being between said reflective layer and said visible information recording layers.

<14> The optical information recording medium of <1>, further comprising, in order:

a first protective layer; an adhesive layer; a second protective layer; and a second reflective layer, all being between said reflective layer and said visible information recording layers.

<15> The optical information recording medium of <1>, further comprising:

at least one second reflective layer that is interleaved with the at least two visible information recording layers.

### BRIEF DESCRIPTION OF THE DRAWING

FIG. 1 shows one example (schematic cross-sectional view) of the optical recording medium of the invention;

FIG. 2 shows a locus of a laser light on the optical disc surface upon formation of an image; and

FIG. 3 is an enlarged view of a laser light in the areas drawn by thick lines in FIG. 2.

### DETAILED DESCRIPTION OF THE INVENTION

Embodiments of the invention will be described below.

The optical information recording medium of the invention has the constitution that at least two visible information recording layers for recording a visible image (visible image recording layers) exist in the layer structure of the medium, with other layers than the two layers being of any kind.

Preferably, the optical information recording medium is an optical information recording medium which is characterized in that the visible information recording layer for recording a visible image (visible image recording layer) contains a compound capable of forming a dye by laser light and/or heat, or an optical information recording medium which is characterized in that it has both a visible information recording layer containing a compound capable of forming a dye by laser light and/or heat and a visible information recording layer for recording a visible image (visible information recording layer) containing a compound capable of undergoing reduction of color and/or decoloration by laser light and/or heat.

Compounds capable of forming a dye by laser light and/or heat will be described below.

Compounds capable of forming a dye by laser light and/or heat are preferably dye precursors which can form a dye by heat generated through light-heat conversion of a laser or by both heat generated through light-heat conversion of a laser and oxidation reaction or which can form a dye whose maximum absorption wavelength is changed by heat generated through light-heat conversion of a laser or by both heat generated through light-heat conversion of a laser and oxidation reaction.

As such dye precursors, compounds represented by the general formula (1) or (2) are preferred.

AP¹-PDH¹-AP² General formula (1)

In the general formula (1), PDH1 represents a group containing a moiety capable of causing a reaction accompanied by change in absorption upon leaving of AP¹ and AP². AP¹ and AP² each represents a group capable of thermally leaving, a group capable of leaving or a hydrogen atom, provided that at least one of AP¹ and AP² is a group capable of thermally leaving.

PD²-AP³ General formula (2)

In the general formula (2), PD² represents a group containing a moiety capable of causing a reaction accompanied by change in absorption upon breakage of the bond with AP³, and AP³ represents a group capable of thermally leaving.

Also, in the case of using the compound represented by the above general formula (2), it is preferred to further incorporate a compound represented by the following general formula (3) in the visible information recording layer.

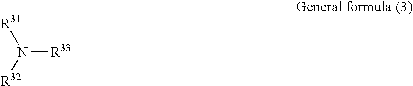

In the general formula (3), R³¹ and R³² each represents a hydrogen atom or an aliphatic group, and R³³ represents an aliphatic group, an aryl group, a hetero ring group, an acyl group, an aromatic oxycarbonyl group, an aliphatic sulfonyl group, an aromatic sulfonyl group, a phosphoryl group, a carbamoyl group or a sulfamoyl group, R³¹ to R³³ may be connected to each other to form a 5- to 7-membered, nitrogen-containing hetero ring. However, the compound represented by the general formula (3) is a compound which has no absorption in the range of from 400 nm to 850 mm.

Further, it is preferred to further incorporate in the visible information recording layer a compound having an absorption in the range of from 400 to 850 nm (a sensitizing dye capable of absorbing a laser light to thermally decompose).

Dye precursors represented by the general formula (1) will be described below.

AP¹-PDH1-AP² General formula (1)

In the general formula (1), PDH1 represents a group containing a moiety capable of causing a reaction accompanied by change in absorption upon leaving of AP¹ and AP².

PDH1 is a group formed by removing two corresponding hydrogen atoms from a dye wherein a conjugation system is shortened by partial reduction of the conjugation system to undergo shift of absorption to shorter wavelength or from a decolored leuco dye.

In the general formula (1), AP¹ and AP² each represents a group capable of thermally leaving, a group capable of leaving or a hydrogen atom, provided that at least one of AP¹ and AP² is a group capable of thermally leaving. AP¹ and AP² are bound to PDH1 at the sites from which the two hydrogen atoms are removed. In the case where one of AP¹ and AP² is a hydrogen atom, it leaves upon aerial oxidation reaction after leaving of the other one of AP¹ and AP², which is capable of thermally leaving, and thereby a desired dye is formed.

Of the compounds represented by the general formula (1), compounds represented by the general formula (1-1) are more preferred.

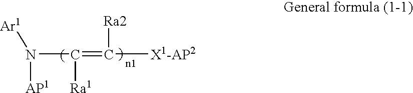

In the general formula (1-1), Ar¹ represents an aryl group or an aromatic hetero ring group, X¹ represents —O— or —N(Ra³)—. Ra¹, Ra², and Ra³ each represents a hydrogen atom or a substituent. Ar¹, Ra¹, Ra², and Ra³ may be connected to each other to form a 5- to 7-membered ring, and n1 represents an integer of 0, 1 or 2. In the case where n1 represents 2, plural Ra¹s and Ra²s may be the same or different.

AP¹ and AP² are the same as defined with respect to the general formula (1) provided that, when n1=0, X¹ represents —N(Ra³)—.

The aryl group represented by Ar¹ may be unsubstituted or may have a substituent, and may be condensed with a ring, and are exemplified by a phenyl group, a 4-methoxyphenyl group and a 4-dimethylaminophenyl group. In particular, an aryl group containing a total of from 6 to 25 carbon atoms are preferred, an aryl group containing a total of from 6 to 20 carbon atoms are more preferred, an aryl group containing a total of from 6 to 15 carbon atoms are still more preferred, an aryl group containing a total of from 6 to 12 carbon atoms are particularly preferred, and an aryl group having a substituted amino group at the p-position with respect to the nitrogen atom-bound position is most preferred.

The aromatic hetero ring group represented by Ar¹ may be unsubstituted or may have a substituent, and may be condensed with a ring, and is exemplified by a pyridine ring and a pyrimidine ring. In particular, a 5- or 6-membered, unsubstituted or substituted aromatic hetero ring group containing a total of from 3 to 30 carbon atoms is preferred, a 6-membered aromatic hetero ring group containing a total of from 3 to 20 carbon atoms are more preferred, a 6-membered aromatic hetero ring group containing a total of from 2 to 15 carbon atoms are still more preferred, and an aromatic hetero ring group having a substituted amino group at the p-position with respect to the nitrogen atom-bound position is most preferred.

As Ar¹, an aryl group is preferred.

The substituent referred to in this specification may be any group that can substitute and is exemplified by an aliphatic group, an aryl group, a hetero ring group, an acyl group, an acyloxy group, an amino group, a substituted amino group, an acylamino group, an aliphatic oxy group, an aryloxy group, a hetero ring oxy group, an aliphatic oxycarbonyl group, an aryloxycarbonyl group, a hetero ring oxycarbonyl group, a carbamoyl group, an aliphatic sulfonyl group, an arylsulfonyl group, a hetero ring sulfonyl group, an aliphatic sulfonyloxy group, an arylsulfonyloxy group, a hetero ring sulfonyloxy group, a sulfamoyl group, an aliphatic sulfonamido group, a hetero ring sulfonamido group, an aliphatic oxycarbonylamino group, an aryloxycarbonylamino group, a hetero ring oxycarbonylamino group, an aliphatic sulfinyl group, an arylsulfinyl group, a hydroxyl group, a cyano group, a carboxyl group, a sulfamoylamino group, a halogen atom, a sulfamoylcarbamoyl group, and a carbamoylsulfamoyl group. The term “aliphatic (group)” means alkyl (group), alkenyl (group) or alkenyl (group) which may or may not be substituted.

The substituent represented by Ra¹, Ra² or Ra³ may be any group that can substitute and is exemplified by those which have been referred to with respect to the foregoing substituents (hereinafter, these substituents being described as “substituents (SUB)”. Preferred examples of Ra¹ and Ra² include a hydrogen atom, an aliphatic group, an aryl group, a hetero ring group, an amino group, a substituted amino group, an acylamino group, an aliphatic oxy group, an aryloxy group, a hetero ring oxy group, an aliphatic oxycarbonyl group, an aryloxycarbonyl group, a hetero ring oxycarbonyl group, a carbamoyl group, an aliphatic sulfonamido group, an arylsulfonamido group, a hetero ring sulfonamido group, an aliphatic oxycarbonylamino group, an aryloxycarbonylamino group, a hetero ring oxycarbonylamino group, a cyano group, a sulfamoylamino group and a halogen atom, with a hydrogen atom, an aliphatic group, an aryl group, a hetero ring group, an aliphatic oxycarbonyl group, a carbamoyl group, a cyano group, a substituted amino group, and an aliphatic oxy group being particularly preferred.

Preferred examples of Ra³ include a hydrogen atom, an aliphatic group, a hetero ring group, an acyl group, an acyloxy group, an aliphatic oxycarbonyl group, an aryloxycarbonyl group, a hetero ring oxycarbonyl group, a carbamoyl group, an aliphatic sulfonyl group, an arylsulfonyl group, and a hetero ring sulfonyl group, with a hydrogen atom and an acyl group being particularly preferred.

More preferably, Ra¹ and Ra² are connected to each other to form a 5-membered aromatic hetero ring or a 6-membered aryl ring, or Ra¹, Ra², and Ra³ are connected to each other to form a 5-membered-5-membered condensed aromatic hetero ring system.

The group capable of thermally leaving represented by AP¹ and AP² is a substituent capable of being decomposed at a temperature of from 120° C. to 300° C. at which thermal decomposition of the dye precursor initiates, thus forming a dye. More preferably, the group capable of thermally leaving is a substituent capable of being decomposed at a temperature of from 150° C. to 250° C. at which thermal decomposition of the dye precursor initiates, with an aliphatic oxycarbonyl group being still more preferred. Among aliphatic oxycarbonyl groups, a primary alkoxycarbonyl group is preferred, a secondary alkoxycarbonyl group is more preferred, and a tertiary alkoxycarbonyl group is still more preferred.

Preferred examples of the group capable of thermally leaving represented by AP¹ and AP² include an aliphatic sulfonyl group, an arylsulfonyl group, an acyl group, an aliphatic sulfinyl group, and an arylsulfinyl group, and more preferred examples thereof include an aliphatic sulfonyl group and an arylsulfonyl group, with an arylsulfonyl group being still more preferred.

AP¹ is preferably a hydrogen atom or a group capable of thermally leaving, more preferably a hydrogen atom or an aliphatic oxycarbonyl group.

AP² is preferably a hydrogen atom or a group capable of leaving, more preferably a hydrogen atom, an aliphatic sulfonyl group or an arylsulfonyl group, with a hydrogen atom or an arylsulfonyl group being still more preferred, provided that at least one of AP¹ and AP² is an aliphatic oxycarbonyl group.

Further, the decomposition temperature of the dye precursor to a dye can be decreased by adding a compound such as an acidic compound or an acid precursor, thus such addition being effective. Examples of such compound include compounds of aliphatic carboxylic acids, aromatic carboxylic acids, aliphatic sulfonic acids, aromatic sulfonic acids, aliphatic sulfinic acids, aromatic sulfinic acids, etc. and precursors thereof.

Preferred examples of the compounds represented by the general formula (1-1) are those compounds which are represented by the following general formulae (1-11), (1-12), and (1-13), more preferably those represented by the general formula (1-11).

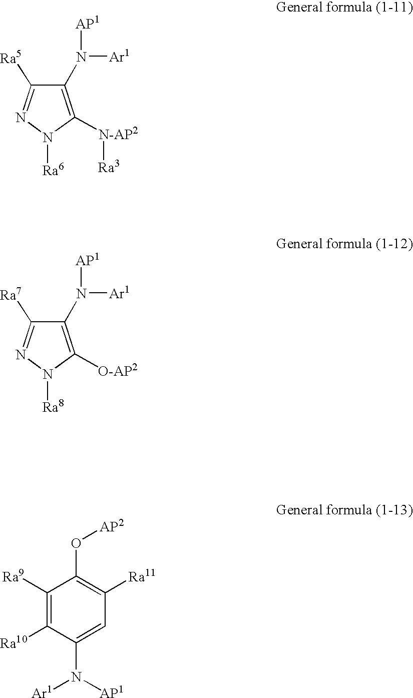

In the general formulae (1-11) to (1-13), Ar¹, AP¹, AP², and Ra³ are the same as defined in the general formulae (1) and (1-1), and preferred scopes are also the same as described there.

Ra⁵ to Ra¹¹ each represents a hydrogen atom or a substituent, and Ra³ and Ra⁶, and Ra⁹ and Ra¹⁰, may be connected to each other to form a 5- to 6-membered ring.

Ra⁵ is preferably an aliphatic group, a hetero ring group, an acylamino group, an aliphatic oxy group, an aryloxy group, an aliphatic oxycarbonyl group, an aryloxycarbonyl group, a hetero ring oxycarbonyl group, a carbamoyl group, an aliphatic sulfonamido group, an arylsulfonamido group, a hetero ring sulfonamido group, an aliphatic oxycarbonylamino group, an aryloxycarbonylamino group, a hetero ring oxycarbonylamino group, a cyano group or a sulfamoylamino group, more preferably an aliphatic group, an aliphatic oxy group, an aryloxy group or a carbamoyl group.

Ra⁶ is preferably an aliphatic group, an aryl group, a hetero ring group, an acyl group, an aliphatic oxycarbonyl group, an aryloxycarbonyl group, a hetero ring oxycarbonyl group, a carbamoyl group, an aliphatic sulfonyl group, an arylsulfonyl group, a hetero ring sulfonyl group, a sulfamoyl group, a sulfamoylcarbamoyl group or a carbamoylsulfamoyl group, more preferably an aliphatic group, an aryl group, a hetero ring group, an acyl group, an aliphatic oxycarbonyl group, a carbamoyl group, an aliphatic sulfonyl group, an arylsulfonyl group, a hetero ring sulfonyl group or a sulfamoyl group, most preferably an aliphatic group, an aryl group or a hetero ring group. Still more preferably, Ra⁶ is connected to Ra³ to form a 5- or 6-membered ring. The 5- or 6-membered ring is particularly preferably a triazole ring, a pyrimidine ring or a triazine ring. The triazole ring and the pyrimidine ring may further have a substituent. As such substituent, those which have been described in the paragraph where substituents (SUB) are described are preferred, with an aryl group or an alkyl group being more preferred.

Ra⁷ is preferably an aliphatic group, a hetero ring group, an acylamino group, an aliphatic oxy group, an aryloxy group, an aliphatic oxycarbonyl group, an aryloxycarbonyl group, a hetero ring oxycarbonyl group, a carbamoyl group, an aliphatic sulfonamido group, an arylsulfonamido group, a hetero ring sulfonamido group, an aliphatic oxycarbonylamino group, an aryloxycarbonylamino group, a hetero ring oxycarbonylamino group, a cyano group or a sulfamoylamino group, more preferably an aliphatic group, a hetero ring group, an acylamino group, an aliphatic oxy group, an aryloxy group, an aliphatic oxycarbonyl group, a carbamoyl group, an aliphatic oxycarbonylamino group or a cyano group, most preferably an aliphatic group, an acylamino group, an aliphatic oxy group or an aryloxy group.

Ra⁸ is preferably an aliphatic group, an aryl group, a hetero ring group, an acyl group, an aliphatic oxycarbonyl group, an aryloxycarbonyl group, a hetero ring oxycarbonyl group, a carbamoyl group, an aliphatic sulfonyl group, an arylsulfonyl group, a hetero ring sulfonyl group, a sulfamoyl group, a sulfamoylcarbamoyl group or a carbamoylsulfamoyl group, more preferably an aliphatic group, an aryl group, a hetero ring group, an acyl group, an aliphatic oxycarbonyl group or a carbamoyl group, most preferably an aryl group or a hetero ring group.

Ra⁹, Ra¹⁰, and Ra¹¹ each is preferably a hydrogen atom, an aliphatic group, an aryl group, a hetero ring group, an acyl group, an acyloxy group, a substituted amino group, an acylamino group, an aliphatic oxy group, an aryloxy group, a hetero ring oxy group, an anliphatic oxycarbonyl group, an aryloxycarbonyl group, a hetero ring oxycarbonyl group, a carbamoyl group, an aliphatic sulfonyl group, an arylsulfonyl group, a hetero ring sulfonyl group, a sulfamoyl group, an aliphatic sulfonamido group, an arylsulfonamido group, a hetero ring sulfonamido group, an aliphatic oxycarbonylamino group, an aryloxycarbonylamino group, a hetero ring oxycarbonylamino group, a carbamoylamino group, a sulfamoylamino group, a halogen atom, a sulfamoylcarbamoyl group or a carbamoylsulfamoyl group, more preferably an aliphatic group, an aryl group, a hetero ring group, an acylamino group, an aliphatic oxycarbonyl group, a carbamoyl group, an aliphatic sulfonyl group, an arylsulfonyl group, a sulfamoyl group, an aliphatic oxycarbonylamino group, a carbamoylamino group, a sulfamoylamino group or a halogen atom, still more preferably an aliphatic group, an acylamino group, an aliphatic oxycarbonyl group, a carbamoyl group, a sulfamoyl group, an aliphatic oxycarbonylamino group, a carbamoylamino group or a halogen atom. Also, Ra⁹ and Ra¹⁰ may preferably be connected to each other to form a 5 or 6-membered ring. Examples of the 5- or 6-membered ring include a benzene ring, a pyrrolidine ring, and a piperidine ring.

Of the compounds represented by the general formulae (1-11) to (1-13), compounds represented by the general formulae (1-11) and (1-12) are preferred, and compounds represented by the general formula (1-11) are still more preferred.

Specific examples of the compounds of the invention represented by the general formula (1) will be shown below which, however, do not limit the invention in any way.

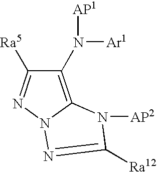

| Com- | | | | | |
|---|---|---|---|---|---|
| pound | | | | | |
| No. | AP1 | AP2 | Ar2 | Ra5 | Ra12 |
| DP1-1 | —COOC₄H₉t | —H | 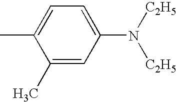 | —C₄H₉t | 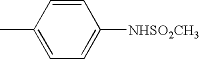 |
| DP1-2 | —COOC₄H₉t | —H | 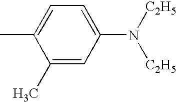 | —C₄H₉t | 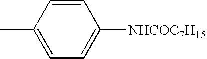 |
| DP1-3 | —COOC₄H₉t | —H | 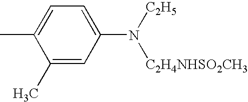 | —C₄H₉t | 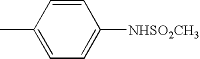 |
| DP1-4 | —COOC₃H₇i | —H | 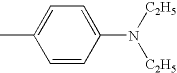 | —CH₃ | 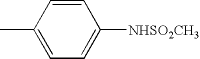 |
| DP1-5 | —COOC₄H₉t | —H | 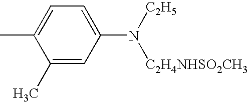 | —C₄H₉t | 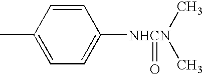 |
| DP1-6 | —COOC₄H₉t | 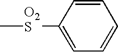 | 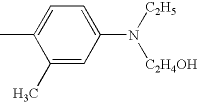 | —C₄H₉t | 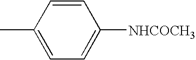 |
| DP1-7 | —COOC₄H₉t | 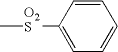 | 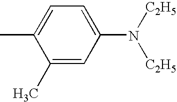 | —C₄H₉t | 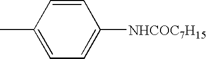 |
| DP1-8 | —COOC₂H₅ | —H | 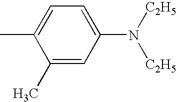 | —C₄H₉t | 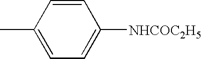 |
| DP1-9 | —COOC₄H₉t | —H | 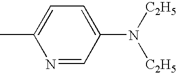 | —C₄H₉t | 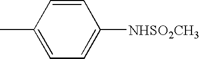 |
| DP1-10 | —COOC₄H₉t | —H | 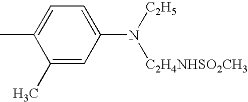 | —CH₃ | 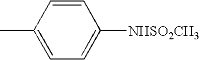 |
| DP1-11 | —COOC₄H₉t | —SO₂CH₃ | 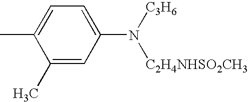 | —CH₃ | 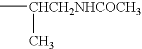 |
| DP1-12 | —COOC₄H₉t | —H | 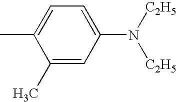 | —OC₂H₅ | 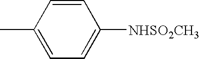 |
| DP1-13 | —COOC₄H₉t | —H | 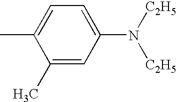 | 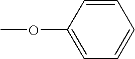 | 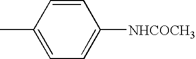 |
| DP1-14 | —H | —COOC₄H₉t | 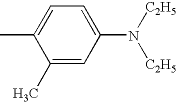 | —C₄H₉t | 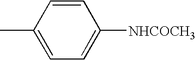 |
| DP1-15 | —COOC₄H₉t | —H | 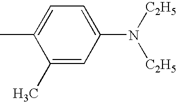 | —C₃H₇i | 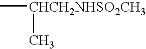 |

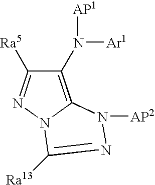

| Compound | | | | | |
|---|---|---|---|---|---|
| No. | AP1 | AP2 | Ar1 | Ra5 | Ra13 |
| DP1-21 | —COOC₄H₉t | —H | 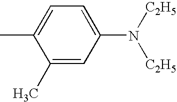 | —C₄H₉t | 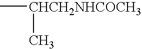 |
| DP1-22 | —COOC₄H₉t | —H | 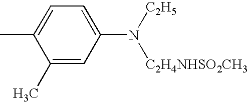 | —C₄H₉t | 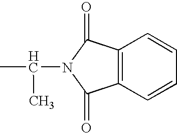 |
| DP1-23 | —COOC₄H₉t | —H | 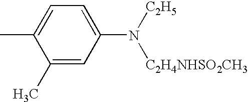 | —C₄H₉t | 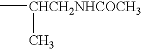 |
| DP1-24 | —COOC₄H₉t | —H | 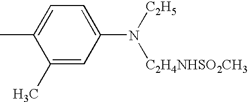 | —CH₃ | 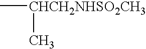 |
| DP1-25 | —COOCH₃ | 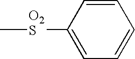 | 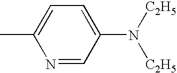 | —OC₂H₅ | 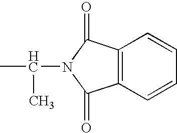 |

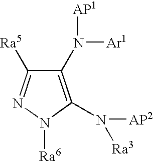

| Com- | | | | | | |
|---|---|---|---|---|---|---|
| pound | | | | | | |
| No. | AP1 | AP2 | Ar1 | Ra5 | Ra3 | Ra6 |
| DP1-31 | —COOC₄H₉t | —H | 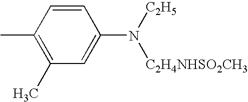 | —C₄H₉t | —H | 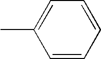 |
| DP1-32 | —COOC₄H₉t | —H | 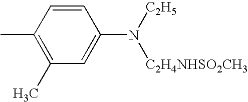 | —OC₂H₅ | —H | 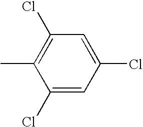 |
| DP1-33 | —COOC₄H₉t | —H | 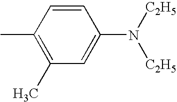 | —CH₃ | —H | 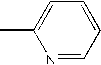 |
| DP1-34 | —COOC₄H₉t | —H | 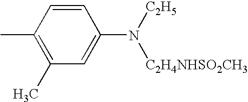 | 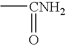 | —COCH₃ | —CH₃ |
| DP1-35 | —COOC₃H₇i | 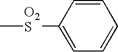 | 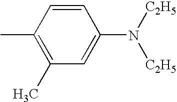 | 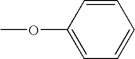 | —H | 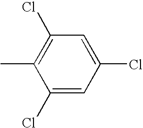 |

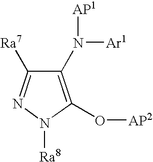

| Compound | | | | | |
|---|---|---|---|---|---|
| No. | AP1 | AP2 | Ar1 | Ra7 | Ra8 |
| DP1-41 | —COOC₄H₉t | —H | 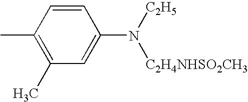 | —CH₃ | 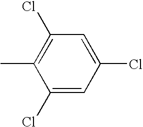 |
| DP1-42 | —COOC₄H₉t | —H | 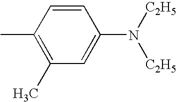 | —OC₂H₅ | 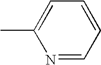 |
| DP1-43 | —COOC₄H₉t | —H | 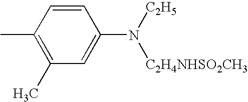 | 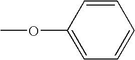 | 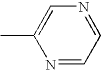 |
| DP1-44 | —COOC₃H₇i | —H | 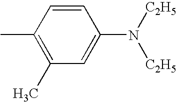 | 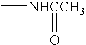 | 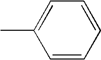 |
| DP1-45 | —COOC₄H₉t | 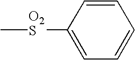 | 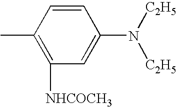 | —CH₃ | 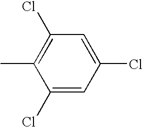 |

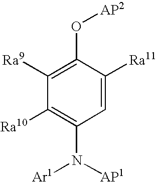

| Compound | | | | | | |
|---|---|---|---|---|---|---|
| No. | AP1 | AP2 | Ar1 | Ra9 | Ra10 | Ra11 |
| DP1-51 | —COOC₄H₉t | —H | 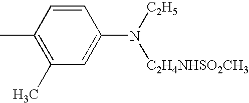 | —Cl | —CH₃ | 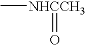 |
| DP1-52 | —COOC₄H₉t | —H | 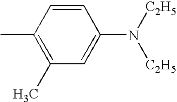 | —Cl | —C₂H₅ | 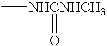 |
| DP1-53 | —COOC₄H₉t | —H | 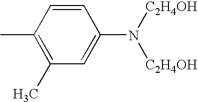 | —H | 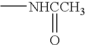 | 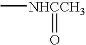 |
| DP1-54 | —COOC₄H₉t | 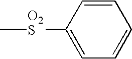 | 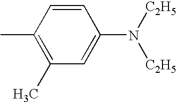 | —Cl | —C₂H₅ | 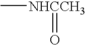 |
| DP1-55 | —COOC₄H₉t | —H | 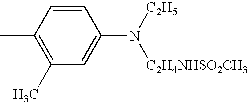 | —Cl | 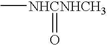 | 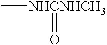 |
| DP1-56 | —COOC₄H₉t | —H | 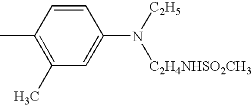 | —Cl | —C₄H₉t | 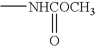 |
| DP1-57 | —COOC₄H₉t | —H | 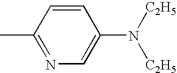 | —Cl | —C₂H₅ | 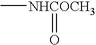 |
| DP1-58 | —COOC₃H₇i | —H | 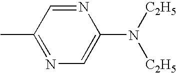 | —Cl | —C₃H₇i | 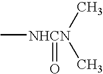 |
| DP1-59 | —COOC₄H₉t | —H | 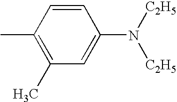 | 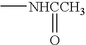 | —H | 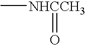 |
| DP1-60 | —COOC₄H₉t | —H | 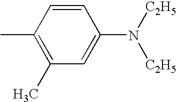 | —Cl | —C₃H₇i | 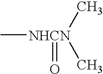 |
| DP1-61 | —H | —COOC₄H₉t | 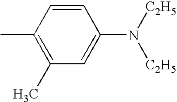 | —Cl | —C₄H₉i | 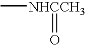 |

| | | |
|---|---|---|
| 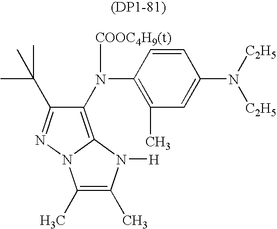 | 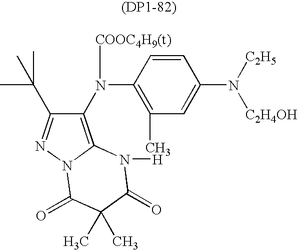 | 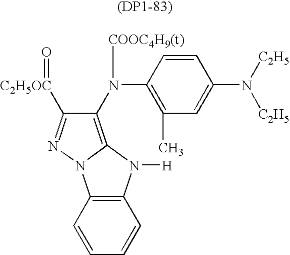 |

| | |
|---|---|
| 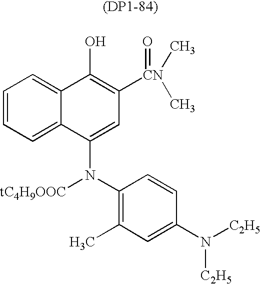 | 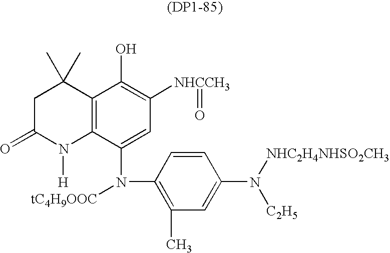 |

| | | |
|---|---|---|
| 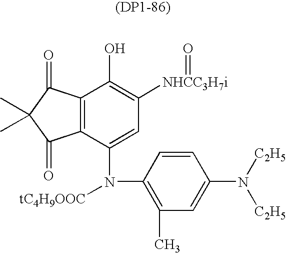 | 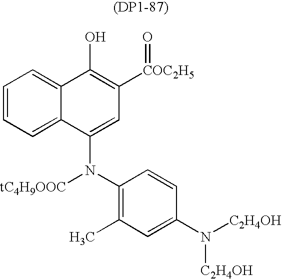 | 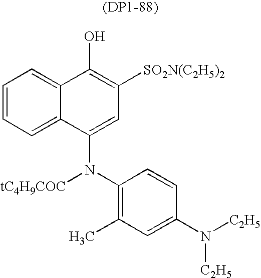 |

| | | |
|---|---|---|
| 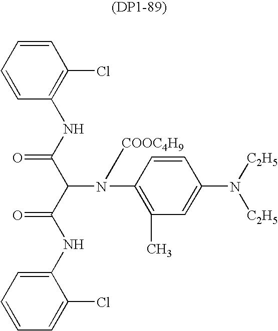 | 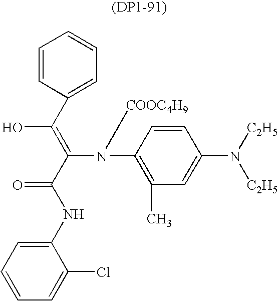 | 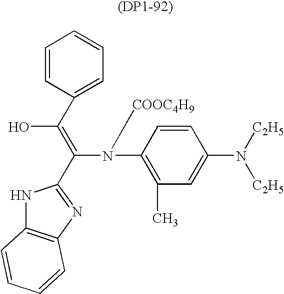 |

| | |
|---|---|
| 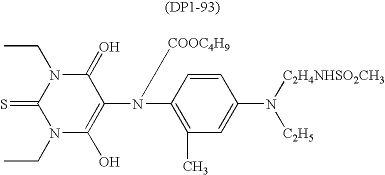 | 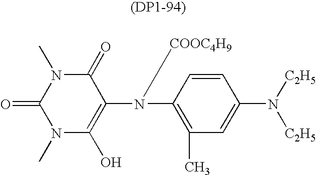 |

| | |
|---|---|
| 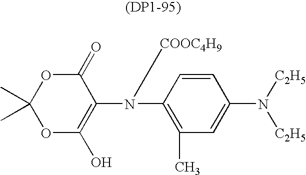 | 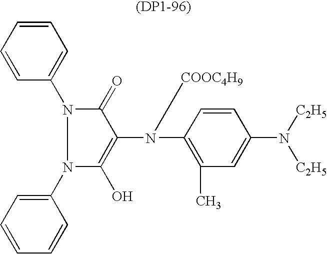 |

| | |
|---|---|
| 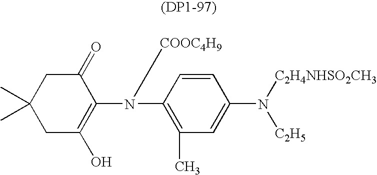 | 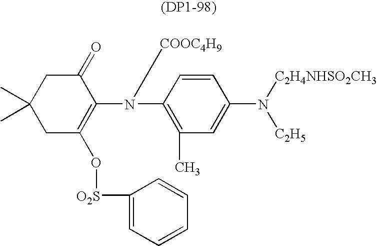 |

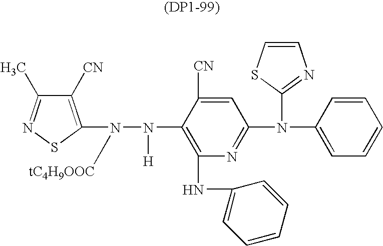

Compounds represented by the general formula (1) can be synthesized by employing common chemical reactions in sequence. The synthesizing route and synthesizing formulation of a specific compound (DP1-1) will be shown below.

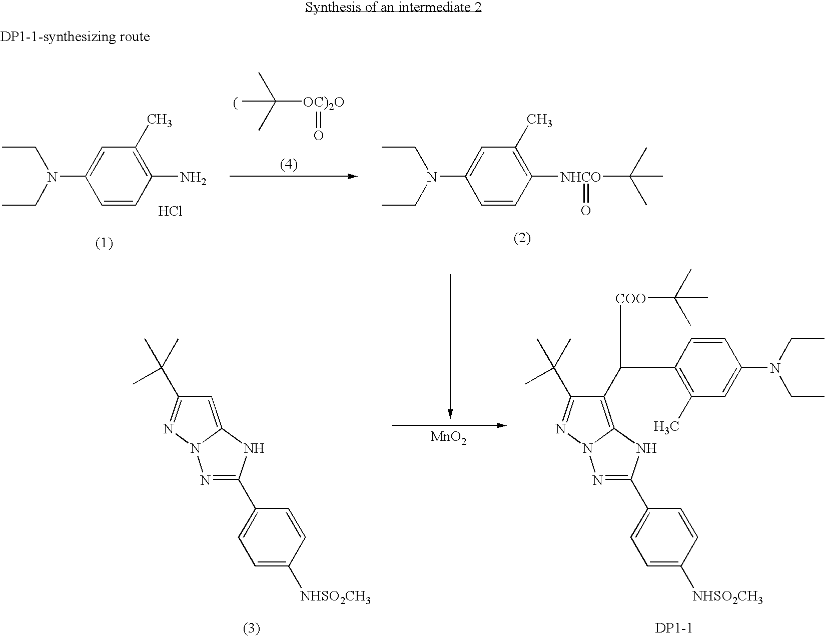

25 g (0.12 mol) of a compound (1) is added to 25 ml of dimethylacetamide and 100 ml of acetonitrile and, under stirring at 15° C., 26.1 g (0.12 mol) of (4) is added thereto, 38 ml (0.27 mol) of triethylamine is dropwise added thereto under stirring at 25° C. Thereafter, the temperature of the solution is increased to 45° C., and the solution is stirred for 2 hours, followed by pouring the reaction solution into 500 ml of ice water under stirring. After further stirring for 30 minutes, crystals formed are collected by filtration, and washed with a sufficient amount of water. The crystals thus obtained are dried to obtain 29 g of an intermediate (2). Yield: 89.5%.

### Synthesis of a Compound DP1-1

4 g (12 mmol) of a compound (3) and 3.5 g (13 mmol) of the intermediate (2) are added to 100 ml of ethanol and, further, 3.4 ml (24 mmol) of triethylamine is added thereto. 3 g (35 mmol) of manganese dioxide is added to the resulting solution under stirring at 25° C., and the resulting mixture is stirred for 10 hours at 50° C. Insolubles are removed by filtration, and the filtrate is concentrated under reduced pressure. The thus-obtained viscous product is purified by silica gel column chromatography (ethyl acetate/n-hexane=2/1) to obtain 5.2 g (amorphous) of the compound DP1-1 of the invention. Yield: 71.2%. mp: 190° C. (dec.).

Dye precursors represented by the general formula (2) will be described below.

PD²-AP³ General formula (2)

In the general formula (2), PD² represents a group containing a moiety capable of causing a reaction accompanied by change in absorption upon breakage of the bond with AP³, and AP³ represents a group capable of thermally leaving. Upon thermal leaving of AP3 from a dye precursor represented by the general formula (2), there is generated a dissociative dye. This dissociative dye is preferably a dissociative benzylidene dye, a dissociative oxonol dye, a dissociative azomethine dye, a dissociative azo dye, or the like, more preferably a dissociative azomethine dye, a dissociative oxonol dye or a dissociative azo dye.

Of the dye precursors represented by the general formula (2), those represented by the general formulae (2-1), (2-2), and (2-3) are more preferred.

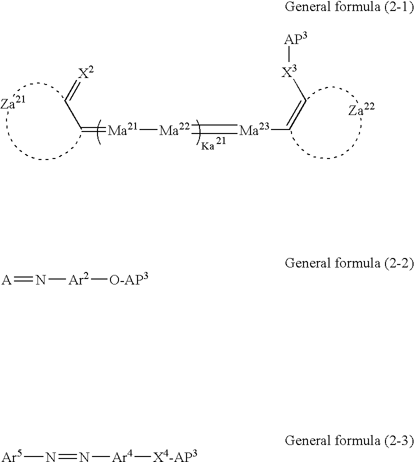

In the general formulae (2-1), (2-2), and (2-3), AP³ is the same as defined in the general formula (2).

In the general formula (2-1), Za²¹ and Za²² each independently represents a group of atoms forming an acidic nucleus together with C—C═X² or C═C—X³-AP³, X² and X³ each independently represents an oxygen atom, a sulfur atom or NR (wherein R represents a hydrogen atom or an alkyl group), Ma²¹, Ma²², and Ma²³ each independently represents a substituted or unsubstituted methine group, Ka²¹ represents an integer in the range of from 0 to 2 and, when Ka²′ represents 2, plural Ma²¹s and plural Ma²² may be the same or different. AP³ is the same as is defined in the general formula (2). The general formula (2-1) includes the tautomer structure of the compound skeleton wherein AP³ substitutes X² at the other end of the dye conjugation system.

In the general formula (2-2), Ar² represents an arylene group, and A represents a substituted aliphatic group, a carbon ring group or a hetero ring group. The general formula (2-2) includes the tautomer structure of the compound skeleton wherein AP³ substitutes A at the other end of the dye conjugation system.

In the general formula (2-3), Ar⁴ represents a divalent substituted aliphatic group, a divalent carbon ring group or a divalent hetero ring group, and Ar⁵ represents an aryl group or a hetero ring group. X⁴ represents a mere single bond or an oxygen atom. The general formula (2-3) includes the tautomer structure of the compound skeleton wherein AP³ substitutes Ar⁵ or the azo group at the other end of the dye conjugation system.

The general formula (2-1) will be described below.

Za²¹ and Za²² each independently represents a group of atoms forming an acidic nucleus. Examples thereof include those which are described in James, The Theory of the Photographic Process, 4^{th} edition, McMillan (1977), page 198. Specifically, there can be illustrated nuclei such as optionally substituted pyrazol-5-one, optionally substituted pyrazolidine-3,5-dione, optionally substituted imidazolin-5-one, optionally substituted hydantoin, optionally substituted 2- or 4-thiohydantoin, optionally substituted 2-imino-oxazolidin-4-one, optionally substituted 2-oxazolin-5-one, optionally substituted 2-thio-oxazoline-2,4-dione, optionally substituted isorhodanine, optionally substituted rhodanine, optionally substituted thiophen-3-one, optionally substituted thiophen-3-one-1,1-dioxide, optionally substituted 3,3-dioxo[1,3]oxathiolan-5-one, optionally substituted indolin-2-one, optionally substituted indolin-3-one, optionally substituted 2-oxoindazolium, optionally substituted 5,7-dioxo-6,7-dihydrothiazolo[3,2-a]pyrimidine, optionally substituted 3,4-dihydroisoquinolin-4-one, optionally substituted 1,3-dioxane-4,6-dione (e.g., merdramic acid), optionally substituted barbituric acid, optionally substituted 2-thiobarbituric acid, optionally substituted coumarin-2,4-dione, optionally substituted indazolin-2-one, optionally substituted pyrido[1,2-a]pyrimidine-1,3-dione, optionally substituted pyrazolo[1,5-b]quinazolone, optionally substituted pyrazolopyridone, and optionally substituted 5- or 6-membered carbon ring (e.g., hexane-1,3-dione, pentane-1,3-dione or indane-1,3-dione), with optionally substituted pyrazol-5-one, optionally substituted pyrazolidine-3,5-dione, optionally substituted barbituric acid, optionally substituted 2-thiobarbituric acid, optionally substituted 1,3-dioxane-4,6-dione and optionally substituted 3,3-dioxo[1,3]oxathiolan-5-one being preferred.

Preferred examples of the acidic nucleus formed by Za²¹ and C—C═X² include those which are described in Japanese Patent Application No. 2007-109393, and more preferred examples thereof include those acidic nuclei which are represented by any one of the following general formulae (A-2) to (A-6).

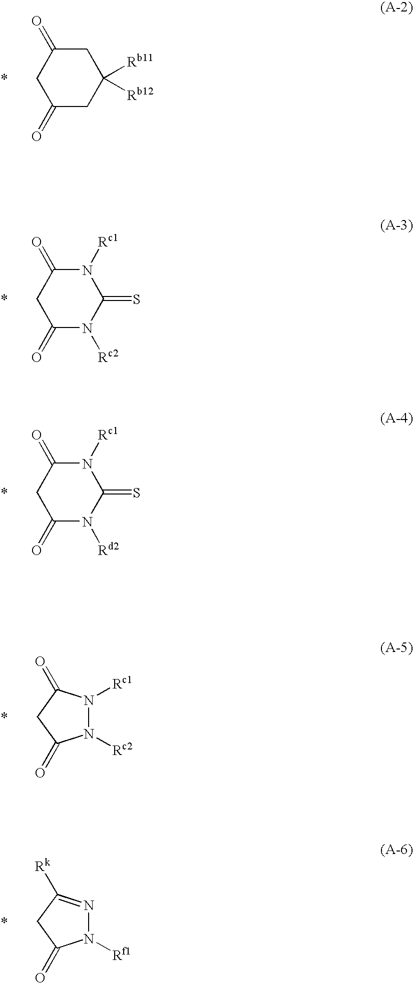

In the above general formulae, * (asterisk) represents the position at which each acidic nucleus described above is connected to Ma²¹, and the substituents of the acidic nuclei, R^{b11, R}^{b12}, R^{c1}, R^{c2}, R^{d1}, R^{d2}, R^{e1}, R^{e2}, R^{f1}, and R^{k}, each independently represents a hydrogen atom or a substituent.

Also, examples of the acidic nucleus formed by Za²² and C═X³-AP³ include those which are described in Japanese Patent Application No. 2007-109393, and more preferred examples thereof include those acidic nuclei which are represented by any one of the following general formulae (B-2) to (B-6) which are tautomers of the acidic nuclei represented by the general formulae (A-2) to (A-6).

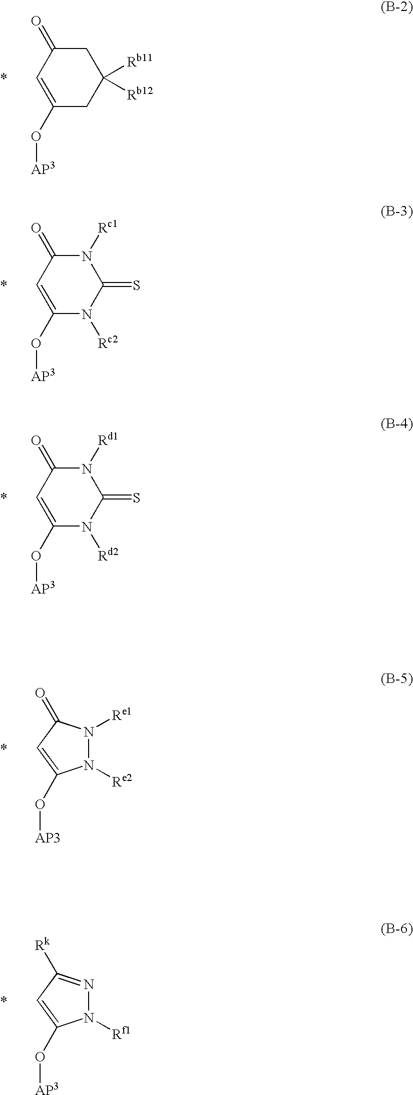

In the above general formulae, * (asterisk) represents the position at which each acidic nucleus described above is connected to Ma²³, with definitions and detailed descriptions of the substituents of the acidic nuclei being the same as given hereinbefore. Also, in the case where the main skeleton of the acidic nucleus formed by Za²¹ is the same as that of the acidic nucleus formed by Za²², plural corresponding substituents existing on the acidic nuclei may be the same or different.

The substituents substituting the acidic nuclei may be any groups that can substitute, and are exemplified by those substituents which have been referred to in the description of the substituents (SUB), with a substituted or unsubstituted alkyl group containing from 1 to 20 carbon atoms or a substituted or unsubstituted aryl group containing from 6 to 20 carbon atoms being preferred.

The acidic nuclei are preferably those which are substituted by a substituted or unsubstituted alkyl group containing from 1 to 20 carbon atoms or by a substituted or unsubstituted aryl group containing from 6 to 20 carbon atoms.

In view of advantages of the invention, the acidic nuclei are preferably those which are represented by (A-2), (A-3), (A-4), (A-5), and (A-6). Structural isomers thereof are similarly preferred.

Ma²¹, Ma²², and Ma²³ each independently represents a substituted or unsubstituted methine group, preferably represents an unsubstituted methine group.

Ka²¹ represents an integer in the range of from 0 to 2. In the case where Ka²¹ represents 2, plural Ma²¹s and Ma²²s may be the same or different. The acidic nucleus formed by Za²² may be a tautomer of the acidic nucleus formed by Za²¹ or may be an acidic nucleus different from the tautomer. Ka²¹ is preferably 1 or 2. Also, the dye precursor represented by the general formula (2-1) may form a dimer or more multimer.

The group capable of thermally leaving represented by AP³ is a substituent capable of being decomposed at a temperature of from 120° C. to 300° C. at which thermal decomposition of the dye precursor initiates, thus forming a dye. More preferably, the group capable of thermally leaving is a substituent capable of being decomposed at a temperature of from 150° C. to 250° C. at which thermal decomposition of the dye precursor initiates, with an aliphatic oxycarbonyl group being still more preferred. Among aliphatic oxycarbonyl groups, a primary alkoxycarbonyl group is preferred, a secondary alkoxycarbonyl group is more preferred, and a tertiary alkoxycarbonyl group is still more preferred.

The compound represented by the general formula (2-1) is preferably used in combination with an onium ion compound, more preferably a quaternary ammonium ion, for improving fastness of the dye to be formed. Of the quaternary ammonium ions, 4,4′-bipyridinium cations represented by the general formula (14) in JP-A-2000-52658 and 4,4′-bipyridinium cations disclosed in JP-A-2002-59652 are particularly preferred.

Next, the general formula (2-2) will be described below.

In the general formula (2-2), Ar² represents a arylene group, and A represents a substituted aliphatic group, a carbon ring group or a hetero ring group. The general formula (2-2) includes the tautomer structure of the compound skeleton wherein AP³ substitutes A at the other end of the dye conjugation system.

The group represented by Ar² is an arylene group which may or may not be substituted and which may be condensed with a ring. As the substituent, any one that can substitute may be employed, and examples thereof include those substituents which have been illustrated in the foregoing paragraph describing the substituents (SUB). As preferred substituents, there can be illustrated a halogen atom, a carbamoyl group, and an acylamino group. Ar² is preferably a 1,4-phenylene group having a total of from 6 to 18 carbon atoms and, assuming that the oxygen-substituted position in the general formula is 1-position, is exemplified by a 2,6-dichloro-1,4-phenylene group, a 2-chloro-1,4-phenylene group, and a 2-acetylamino-6-chloro-1,4-phenylene group.

Preferred examples of the group represented by A include those which are described in Japanese Patent Application No. 2007-109393, and more preferred examples thereof include those groups which are represented by the following formulae (A¹-1), (A¹-7), (A¹-8), and (A¹-9).

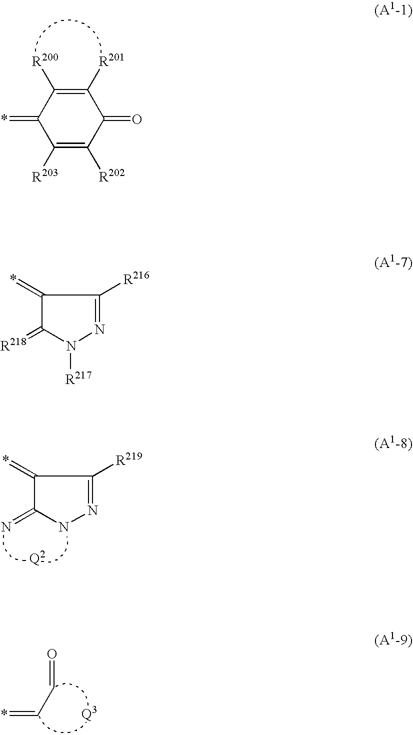

In the above general formulae, * (asterisk) represents the position at which the group is connected to the nitrogen atom in the general formula (2-2). In the above formulae, R²¹⁸ represents an oxygen atom or ═N—R′ (wherein R′ represents a hydrogen atom, an aliphatic group, an acyl group or a sulfonyl group), and R²⁰⁰ to R²⁰³, and R²¹⁶ to R²¹⁹ each independently represents a hydrogen atom or a substituent. R²⁰⁰ and R²⁰¹ may be connected to each other to form a ring. As the ring to be formed, a 5- to 7-membered ring is preferred.

As the substituent, any one that can substitute may be employed, and examples thereof include those various substituents which have been referred to in the foregoing description describing the substituents (SUB). In the case where the compound of the general formula (2-2) is in the form of a multipolymer such as a dimer or a trimer, the substituent may be multivalent equal to or more than divalent. Preferred examples of the substituent include an aliphatic group, an aryl group, a hetero ring group, an acyl group, an acylamino group, an aliphatic oxy group, an aryloxy group, an aliphatic oxycarbonyl group, a carbamoyl group, analiphatic sulfonyl group, an arylsulfonyl group, a sulfamoyl group, an aliphatic sulfonamido group, an arylsulfonamido group, an amino group, an aliphatic amino group, an arylamino group, a hetero ring amino group, a carbamoylamino group, a sulfamoylamino group, a hydroxy group, and a cyano group.

Q² represents a group of non-metallic atoms necessary for forming a ring together with the two nitrogen atoms adjacent to Q¹, and Q³ represents a group of non-metallic atoms necessary for forming a ring together with the two carbon atoms adjacent to Q³. The ring to be formed is preferably a 5 to 7-membered ring.

Groups represented by formulae (A¹-1), (A¹-7), (A¹-8), and (A¹-9) will be described one by one below.

### (A¹-I)

In formula (A¹-I), R²⁰⁰ is preferably a hydrogen atom, an aliphatic group, an aryl group, a hetero ring group, an acyl group, an acylamino group, an aliphatic oxy group, an aliphatic sulfonamido group, an arylsulfonamido group, a halogen atom, a carbamoylamino group, a sulfamoylamino group, a hydroxy group or a cyano group, more preferably an aliphatic group, an acylamino group, an aliphatic sulfonamido group, an arylsulfonamido group, a carbamoylamino group or a sulfamoylamino group, most preferably an aliphatic group, an acylamino group or a carbamoylamino group.

R²⁰¹ is preferably a hydrogen atom, an aliphatic group, an acylamino group, an aliphatic sulfonamido group, an arylsulfonamido group, a halogen atom, a carbamoylamino group, a sulfamoylamino group or a cyano group, more preferably a hydrogen atom, a halogen atom, an acylamino group or a carbamoylamino group,

The ring formed by R²⁰⁰ and R²⁰¹ connected to each other is preferably a 5- to 7-membered ring, more preferably a 5- or 6-membered hetero ring or a 6-membered aryl.

R²⁰² is preferably a hydrogen atom, an aliphatic group, a hetero ring group, an acyl group, an acylamino group, an aliphatic oxy group, an aliphatic oxycarbonyl group, a carbamoyl group, a sulfamoyl group, an aliphatic sulfonamido group, an arylsulfonamido group, an amino group, an aliphatic amino group, an arylamino group, a carbamylamino group, a sulfamoylamino group or a cyano group, more preferably a hetero ring group, an acyl group, an acylamino group, an aliphatic oxycarbonyl group, a carbamoyl group, a sulfamoyl group, an aliphatic sulfonamido group, an arylsulfonamido group, a carbamoylamino group or a sulfamoylamino group, most preferably an acylamino group, an aliphatic oxycarbonyl group, a carbamoyl group, a carbamoylamino group or a sulfamoyl group.

R²⁰³ is preferably a hydrogen atom, an aliphatic group, an acylamino group or a halogen atom, more preferably a hydrogen atom.

### (A¹-7)

In formula (A¹-7), R²¹⁶ is preferably an aliphatic group, an aryl group, a hetero ring group, an acyl group, an acylamino group, an aliphatic oxy group, all aliphatic oxycarbonyl group, a carbamoyl group, an aliphatic amino group, an arylamino group, a hetero ring amino group, a carbamoylamino group, a sulfamoylamino group, a hydroxy group or a cyano group, more preferably an aliphatic group, a hetero ring group, an acyl group, an acylamino group, an aliphatic oxycarbonyl group, a carbamoyl group, an arylamino group, a hetero ring amino group, a carbamoylamino group or a cyano group, most preferably an acylamino group, an aliphatic oxycarbonyl group, a carbamoyl group, an arylamino group, a carbamoylamino group or a cyano group.

R²¹⁷ is preferably an aliphatic group, an aryl group, a hetero ring group, an acyl group, an aliphatic oxycarbonyl group or a carbamoyl group, more preferably an aliphatic group, an aryl group or a hetero ring group, most preferably an aryl group.

R²¹⁸ is preferably an oxygen atom, ═N—R′ (wherein R′ represents a hydrogen atom, an aliphatic group, an acyl group or a sulfonyl group), more preferably an oxygen atom, ═NH or ═N aliphatic group, still more preferably an oxygen atom or ═NH.

In formula (A¹-8), R²¹⁹ is preferably a hydrogen atom, an aliphatic group, an aryl group, a hetero ring group, an acylamino group, an aliphatic oxy group, an aryloxy group, an arylamino group, a hetero ring amino group or a carbamoylamino group, more preferably an aliphatic group, an aliphatic oxy group or an aryloxy group.

The ring formed by the two nitrogen atoms adjacent to Q² is preferably a 5- to 7-membered ring, more preferably a 5- or 6-membered ring. Specific examples thereof include a 1,2,4-triazole ring and a pyrimidine ring.

### (A¹-9)

In formula (A¹-9), the ring formed by the two carbon atoms adjacent to Q³ is preferably a 5- to 7-membered ring, more preferably a 5- or 6-membered ring. Also, those groups which are represented by formulae (A-2), (A-3), (A-4), and (A-5), falling within the category of formula (A¹-9) specified in the general formula (2-1), are preferred. The scope of the substituents for formulae (A-2), (A-3), (A-4), and (A-5), and the preferred scope thereof are the same as specified in the paragraph of the general formula (2-1).

AP³ in the general formula (2-2) is the same as that described in the general formula (2-1).

Next, the general formula (2-3) will be described below.

Preferred examples of the group represented by Ar⁴-4-X⁴ in the general formula (2-3) include those which are described in Japanese Patent Application No. 2007-109393, and more preferred examples thereof include those groups which are represented by the following formulae (A²-1), (A²-3), (A²-7), and (A²-8). * (asterisk) represents the position at which the group is connected to the azo group in the general formula (2-3), and ** represents the position at which the group is connected to AP³.

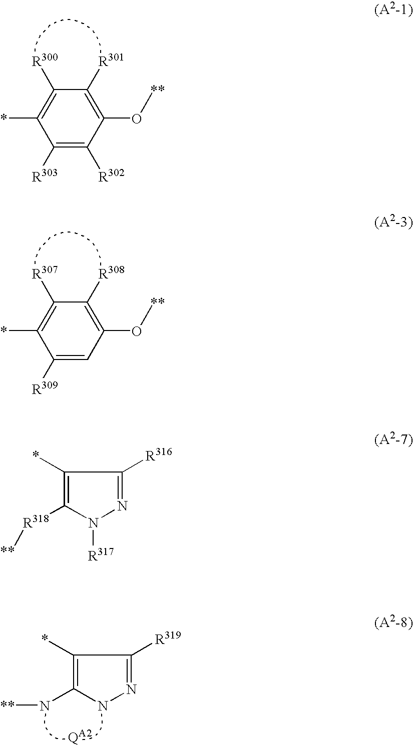

In the above description, R³¹⁶ is an oxygen atom, —N(R′)- (wherein R′ represents a hydrogen atom, an aliphatic group, an acyl group or a sulfonyl group), and R³⁰⁰ to R³⁰³, R³⁰⁷ to R³⁰⁹, and R³¹⁶ to R³¹⁹ each independently represents a hydrogen atom or a substituent. R³⁰⁰ and R³⁰¹, and R³⁰⁷ and R³⁰⁸, may be connected to each other to form a ring. As the ring to be formed, a 5- to 7-membered ring is preferred.

The substituent may be any group that can substitute, and may further have a substituent, and examples thereof include those various substituents which have been referred to in the foregoing description describing the substituents (SUB). Preferred examples of the substituent include an aliphatic group, an aryl group, a hetero ring group, an acyl group, an acylamino group, an aliphatic oxy group, an aryloxy group, an aliphatic oxycarbonyl group, a carbamoyl group, an aliphatic sulfonyl group, an arylsulfonyl group, a sulfamoyl group, an aliphatic sulfonamido group, an arylsulfonamido group, an amino group, an aliphatic amino group, an arylamino group, a hetero ring amino group, a carbamoylamino group, a sulfamoylamino group, a hydroxyl group, and a cyano group.

The foregoing Q^{A2} represents a group of non-metallic atoms necessary for forming a ring together with the two nitrogen atoms adjacent to Q^{A2}. The ring to be formed is preferably a 5- to 7-membered ring.

Groups represented by formulae (A²-1), (A²-3), (A²-7), and (A²-8) will be described in detail one by one below.

### (A²-1)

In formula (A²-1), R³⁰⁰ is preferably a hydrogen atom, an aliphatic group, an aryl group, a hetero ring group, an acyl group, an acylamino group, an aliphatic oxy group, an aliphatic sulfonamido group, an arylsulfonamido group, a halogen atom, a carbamoylamino group, a sulfamoylamino group, a hydroxyl group or a cyano group, more preferably a hydrogen atom, an aliphatic group, an acylamino group, an aliphatic sulfonamido group, an arylsulfonamido group, a carbamoylamino group or a sulfamoylamino group, most preferably a hydrogen atom, an aliphatic group, an acylamino group or a carbamoylamino group.

R³⁰¹ is preferably a hydrogen atom, an aliphatic group, an acylamino group, an aliphatic sulfonamido group, an arylsulfonamido group, a halogen atom, a carbamoylamino group, a sulfamoylamino group or a cyano group, more preferably a hydrogen atom, a halogen atom or an acylamino group.

The ring formed by R³⁰⁰ and R³⁰¹ connected to each other is preferably a 5- to 7-membered ring, more preferably a 5- or 6-membered monocyclic hetero ring or a 6-membered benzene ring.

R³⁰² is preferably a hydrogen atom, an aliphatic group, a hetero ring group, an acyl group, an acylamino group, an aliphatic oxy group, an aliphatic oxycarbonyl group, a carbamoyl group, a sulfamoyl group, an aliphatic sulfonamido group, an arylsulfonamido group, an amino group, an aliphatic amino group, an arylamino group, a carbamoylamino group, a sulfamoylamino group or a cyano group, more preferably a hetero ring group, an acyl group, an acylamino group, an aliphatic oxycarbonyl group, a carbamoyl group, a sulfamoyl group, an aliphatic sulfonamido group, an arylsulfonamido group, a carbamoylamino group or a sulfamoylamino group, most preferably an acylamino group, an aliphatic oxycarbonyl group, a carbamoyl group, a carbamoylamino group or a sulfamoyl group.

R³⁰³ is preferably a hydrogen atom, an aliphatic group, an acylamino group or a halogen atom, more preferably a hydrogen atom.

### (A²-3)

In formula (A²-3), R³⁰⁷ is preferably a hydrogen atom, an aliphatic group, an aryl group, a hetero ring group, an acyl group, an acylamino group, an aliphatic oxy group, an aliphatic sulfonamido group, an arylsulfonamido group, a halogen atom, a carbamoylamino group, a sulfamoylamino group, a hydroxy group or a cyano group, more preferably a hydrogen atom, an aliphatic group, an acylamino group, an aliphatic sulfonamido group, an arylsulfonamido group, a carbamoylamino group or a sulfamoylamino group, most preferably a hydrogen atom, an aliphatic group, an acylamino group or a carbamoylamino group.

R³⁰⁸ is preferably an aliphatic group, an acylamino group, an aliphatic sulfonamido group, an arylsulfonamido group, a halogen atom, an aliphatic oxycarbonyl group, a carbamoylamino group, a sulfamoylamino group or a cyano group, more preferably an aliphatic group, a halogen atom, an acylamino group, a carbamoylamino group, a halogen atom or an aliphatic oxycarbonyl group.

The ring formed by R³⁰⁷ and R³⁰⁸ connected to each other is preferably a 5- to 7-membered ring, more preferably a 5- or 6-membered monocyclic hetero ring or a 6-membered benzene ring.

R³⁰⁹ is preferably a hydrogen atom, an aliphatic group, a hetero ring group, an acyl group, an acylamino group, an aliphatic oxy group, an aliphatic oxycarbonyl group, a carbamoyl group, a sulfamoyl group, an aliphatic sulfonamido group, an arylsulfonamido group, an amino group, an aliphatic amino group, an arylamino group, a carbamoylamino group, a sulfamoylamino group or a cyano group, more preferably a hydrogen atom, a hetero ring group, an acyl group, an acylamino group, an aliphatic oxycarbonyl group, a carbamoyl group, an aliphatic sulfonamido group, an arylsulfonamido group or a carbamoylamino group, most preferably a hydrogen atom, a hetero ring group, an acyl group, an acylamino group, an aliphatic oxycarbonyl group, a carbamoyl group or a carbamoylamino group.

### (A²-7)

In Formula (A²-7), R³¹⁶ is Preferably an Aliphatic Group, an Aryl Group, a hetero ring group, an acyl group, an acylamino group, an aliphatic oxy group, an aliphatic oxycarbonyl group, a carbamoyl group, an aliphatic amino group, an arylamino group, a hetero ring amino group, a carbamoylamino group, a sulfamoylamino group, a hydroxy group or a cyano group, more preferably an aliphatic group, a hetero ring group, an acyl group, an acylamino group, an aliphatic oxycarbonyl group, a carbamoyl group, an arylamino group, a hetero ring amino group, a carbamoylamino group or a cyano group, most preferably an acylamino group, an aliphatic oxycarbonyl group, a carbamoyl group, an arylamino group, a carbamoylamino group or a cyano group.

R³¹⁷ is preferably an aliphatic group, an aryl group, a hetero ring group, an acyl group, an aliphatic oxycarbonyl group or a carbamoyl group, more preferably an aliphatic group, an aryl group or a hetero ring group, most preferably an aryl group,

R³¹⁸ is preferably an oxygen atom, —N(R′)— (wherein R′ represents a hydrogen atom, an aliphatic group or an acyl group or a sulfonyl group), more preferably an oxygen atom, —NH— or —N-aliphatic-group, still more preferably an oxygen atom or —NH—.

### (A²-8)

In Formula (A²-8), R³¹⁹ is preferably a hydrogen atom, an aliphatic group, an aryl group, a hetero ring group, an acylamino group, an aliphatic oxy group, an aryloxy group, an arylamino group, a hetero ring amino group or a carbamoylamino group, more preferably an aliphatic group, an aliphatic oxy group or an aryloxy group.

The ring formed by the two nitrogen atoms adjacent to Q^{A2} is preferably a 5- to 7-membered ring, more preferably a 5- or 6-membered ring. Specific examples thereof include a 1,2,4-triazole ring and a pyrimidine ring.

### (A²-9)

In formula (A²-9), the ring formed by the two carbon atoms adjacent to Q^{A3} is preferably a 5- to 7-membered ring, more preferably a 5- or 6-membered ring, particularly preferably a 6-membered hetero ring.

Of the groups represented by formulae (A²-1), (A²-3), (A²-7), and (A²-8), the groups (A²-1) and (A²-8) are more preferred, and the group (A²-1) is most preferred.

The aryl group of Ar⁵ is a substituted or unsubstituted, optionally condensed aryl group containing preferably a total of from 6 to 20 carbon atoms, more preferably a total of from 6 to 15 carbon atoms. As the substituent, any one that can substitute may be employed, and examples thereof include those substituents which have been referred to in the foregoing description describing the substituents (SUB). Preferred examples of the substituents are an aliphatic group, an acyl group, a substituted amino group, an acylamino group, an aliphatic oxy group, an aliphatic oxycarbonyl group, a carbamoyl group, an aliphatic sulfonyl group, a sulfamoyl group, an aliphatic sulfonamido group, an arylsulfonamido group, an aliphatic oxycarbonyl group, a cyano group, and a halogen atom.

The hetero ring group of Ar⁵ is a substituted or unsubstituted, optionally condensed 5- to 7-membered hetero ring group containing preferably a total of from 2 to 20 carbon atoms, more preferably a 5- to 6-membered hetero ring containing a total of from 2 to 15 carbon atoms. As the substituent, any one that can substitute may be employed, and examples thereof include those substituents which have been referred to in the foregoing description describing the substituents (SUB). Preferred examples of the substituents are an aliphatic group, an acyl group, a substituted amino group, an acylamino group, an aliphatic oxy group, an aliphatic oxycarbonyl group, a carbamoyl group, an aliphatic sulfonyl group, a sulfamoyl group, an aliphatic sulfonamido group, an arylsulfonamido group, an aliphatic oxycarbonyl amino group, a cyano group, and a halogen atom.

Specific cyclic compounds of Ar⁵ include a benzene ring, a naphthalene ring, a pyrrole ring, a thiophene ring, a furan ring, an imidazole ring, a pyrazole ring, an oxazole ring, an ixoxazole ring, a 1,2,3-triazole ring, a 1,2,4-triazole ring, a thiazole ring, an isothiazole ring, a 1,3,4-thiadiazole ring, a 1,2,4-thiadiazole ring, a pyridine ring, a pyrimidine ring, a quinoline ring, a benzotriazole ring, a benzoisothiazole ring, a benzothiazole ring, a benzimidazole ring, an indazole ring, a benzoxazole ring, and a benzisoxazole ring.

As a preferred group represented by Ar⁵, there are illustrated those which are described in Japanese Patent Application No. 2007-109393, and preferred examples thereof are those which are represented by the following formulae (A3-2), (A3-5), (A3-8), (A3-10) to (A3-13), (A3-18), and (A3-19). In the formulae, * (asterisk) represents a bond to the azo group.

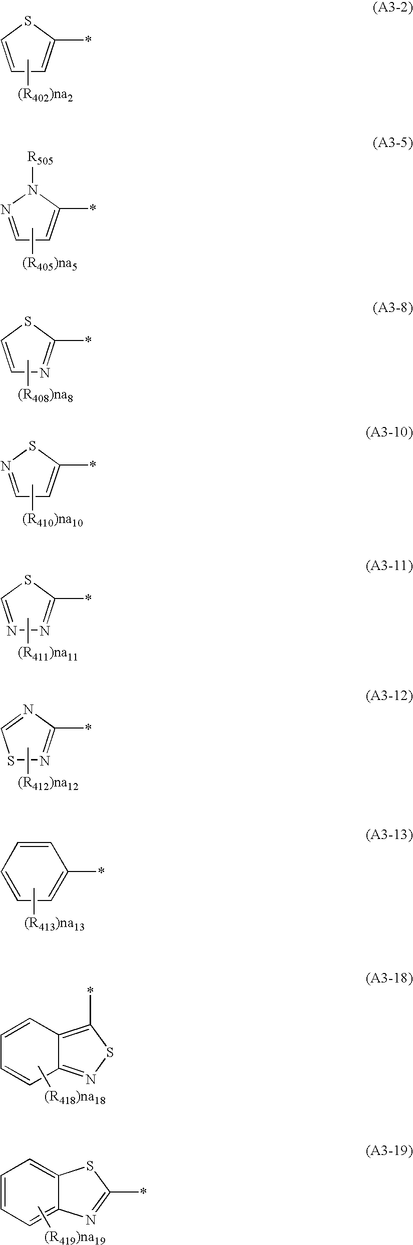

In the general formulae (A3-2), (A3-5, (A3-8), (A3-10) to (A3-13), (A3-18), and (A3-19), R₄₀₂, R₄₀₅, R₄₀₈, R₄₁₀ to R₄₁₃, R₄₁₈, R₄₁₉, and R₅₀₅ each represents a hydrogen atom or a substituent, na₁₁ and na₁₂ each represents 1, na₅, na₈, and na₁₀ each represents 2, na₂₅ represents 3, na₁₈ and na₁₉ each represents 4, na₁₃ represents 5 and, when plural substituents exist, they may be the same or different. As the substituent, any one that can substitute may be employed, and examples thereof include those substituents which have been referred to in the foregoing description describing the substituents (SUB).

In the general formula (2-3), a preferred scope of AP³ is the same as in the general formula (2-1).

Of the compounds of the invention represented by the general formulae (2-1) to (2-3), the compounds represented by the general formulae (2-2) or (2-3) are preferred, and the compounds represented by the general formula (2-2) are more preferred.

Specific examples of the compounds of the invention represented by the general formula (2) include those which are described in Japanese Patent Application No. 2007-109393, and preferred examples thereof are those shown below which, however, do not limit the invention in any way.

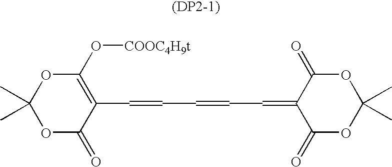

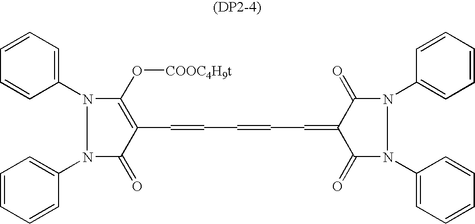

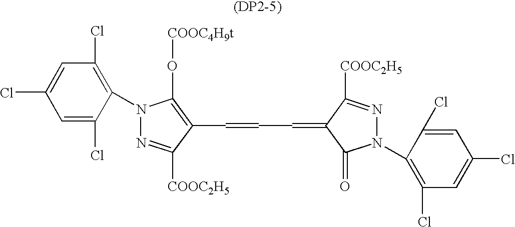

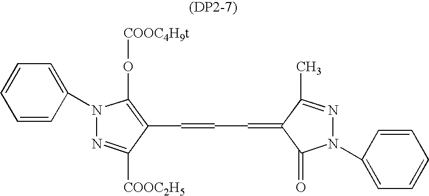

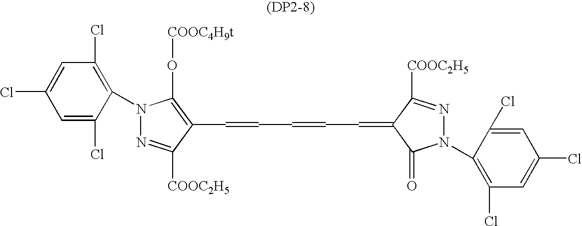

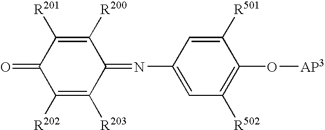

| Compound | | | | | | | |
|---|---|---|---|---|---|---|---|
| No. | R200 | R201 | R202 | R203 | R501 | R502 | AP3 |
| DP2-31 | —C₂H₅ | —Cl | 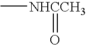 | —H | —Cl | —Cl | —COOC₄H₉t |
| DP2-32 | 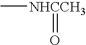 | —H | 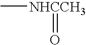 | —H | —Cl | —Cl | —COOC₄H₉t |
| DP2-33 | 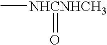 | —H | 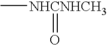 | —H | —Cl | —Cl | —COOC₄H₉t |
| DP2-34 | —C₂H₅ | —Cl | 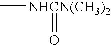 | —H | —Cl | —Cl | —COOC₄H₉t |
| DP2-35 | —C₃H₇i | —Cl | 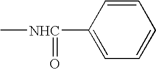 | —H | —Cl | —Cl | —COOC₄H₉t |

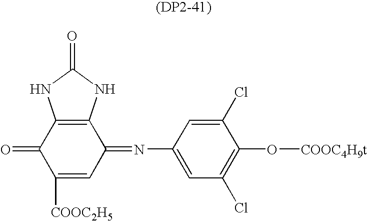

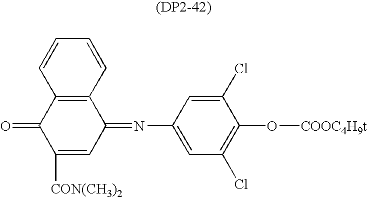

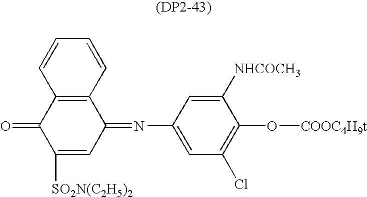

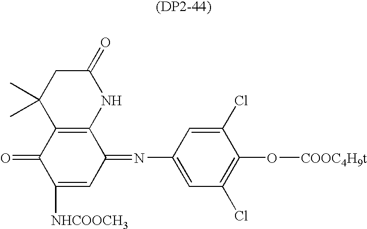

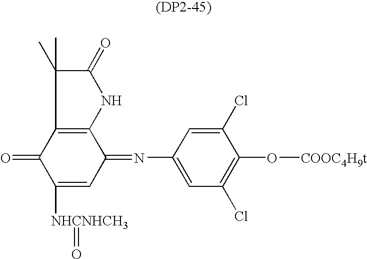

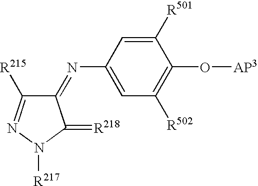

| Compound | | | | | | |
|---|---|---|---|---|---|---|
| No. | R216 | R217 | R218 | R501 | R502 | AP3 |
| DP2-51 | 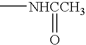 | 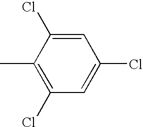 | ═O | —Cl | —Cl | 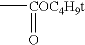 |
| DP2-52 | 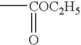 | 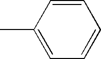 | NH | —Cl | —Cl | 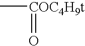 |
| DP2-54 | 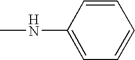 | 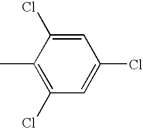 | ═O | —Cl | —Cl | 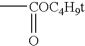 |
| DP2-55 | 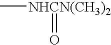 | 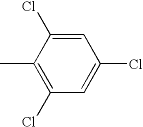 | ═O | —Cl | —Cl | 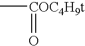 |
| DP2-57 | 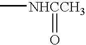 | 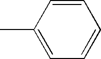 | ═O | —Cl | 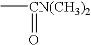 | 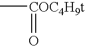 |

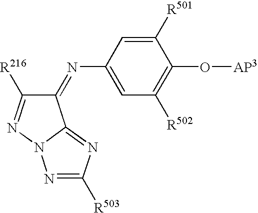

| Compound | | | | | |
|---|---|---|---|---|---|
| No. | R216 | R503 | R501 | R502 | AP3 |
| DP2-61 | —C₄H₉t | 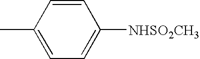 | —Cl | —Cl | 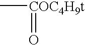 |
| DP2-62 | —CH₃ | 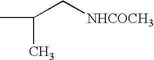 | —Cl | —Cl | 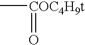 |
| DP2-64 | —OC₂H₅ | 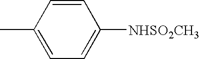 | —Cl | —Cl | 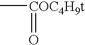 |
| DP2-65 | 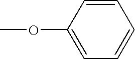 | 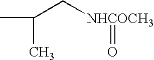 | —Cl | —Cl | 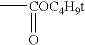 |
| DP2-66 | —C₄H₉t | 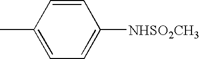 | —Cl | 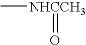 | 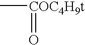 |

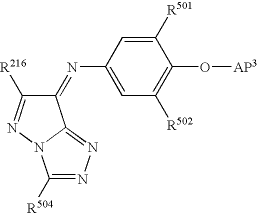

| Compound | | | | | |
|---|---|---|---|---|---|
| No. | R216 | R504 | R501 | R502 | AP3 |
| DP2-71 | —C₄H₉t | 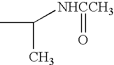 | —Cl | —Cl | 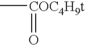 |
| DP2-73 | —C₄H₉t | 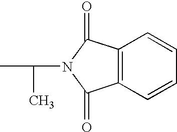 | —Cl | —Cl | 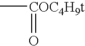 |
| DP2-74 | —OC₂H₅ | 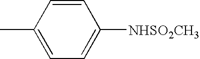 | —Cl | —Cl | 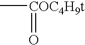 |
| DP2-75 | 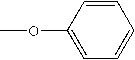 | 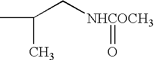 | —Cl | 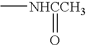 | 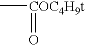 |
| DP2-76 | —C₄H₉t | 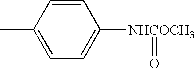 | —Cl | —Cl | 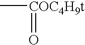 |

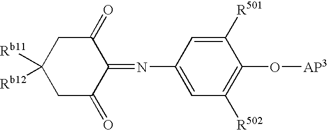

| Compound | | | | | |
|---|---|---|---|---|---|
| No. | Rb11 | Rb12 | R501 | R502 | AP3 |
| DP2-81 | —CH₃ | —CH₃ | —Cl | —Cl | 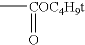 |
| DP2-82 | —CH₃ | —CH₃ | —Cl | 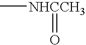 | 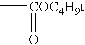 |
| DP2-83 | —CH₃ | —CH₃ | —Cl | 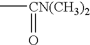 | 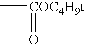 |

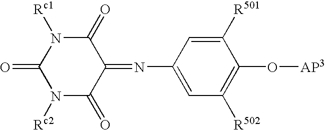

| Compound | | | | | |
|---|---|---|---|---|---|
| No. | Rc1 | Rc2 | R501 | R502 | AP3 |
| DP2-91 | —CH₃ | —CH₃ | —Cl | —Cl | 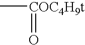 |
| DP2-92 | —CH₃ | 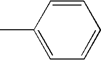 | —Cl | —Cl | 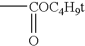 |
| DP2-93 | —C₂H₄OC₂H₅ | —C₂H₄OC₂H₅ | —Cl | —Cl | 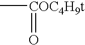 |
| DP2-94 | —CH₃ | —CH₂COOCH₃ | —Cl | 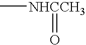 | 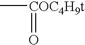 |
| DP2-95 | —CH₃ | —C₄H₉t | —Cl | —Cl | 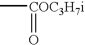 |

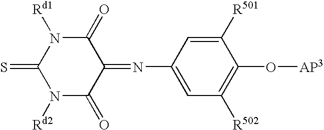

| Compound | | | | | |
|---|---|---|---|---|---|
| No. | Rd1 | Rd2 | R501 | R502 | AP3 |
| DP2-101 | —C₂H₅ | —C₂H₅ | —Cl | —Cl | 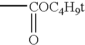 |
| DP2-102 | —CH₃ | 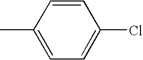 | —Cl | —Cl | 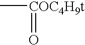 |
| DP2-103 | —C₂H₅ | —C₂H₄NHSO₂CH₃ | —Cl | —Cl | 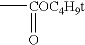 |
| DP2-104 | —CH₃ | 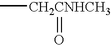 | —Cl | 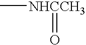 | 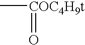 |
| DP2-105 | —CH₃ | —C₄H₉t | —Cl | —Cl | 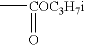 |

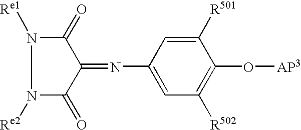

| Compound | | | | | |
|---|---|---|---|---|---|
| No. | Re1 | Re2 | R501 | R502 | AP3 |
| DP2-111 | 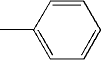 | 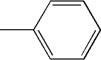 | —Cl | —Cl | 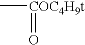 |
| DP2-112 | —CH₃ | —CH₃ | —Cl | —Cl | 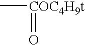 |
| DP2-113 | —C₂H₅ | —C₂H₄NHSO₂CH₃ | —Cl | —Cl | 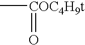 |
| DP2-114 | —CH₃ | 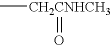 | —Cl | 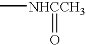 | 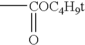 |
| DP2-115 | —H | —C₄H₉t | —Cl | —Cl | 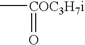 |

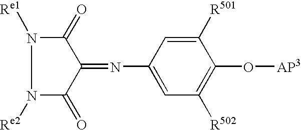

| Compound | | | | | |
|---|---|---|---|---|---|
| No. | Re1 | Re2 | R501 | R502 | AP3 |
| DP2-111 | 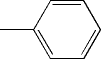 | 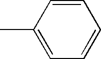 | —Cl | —Cl | 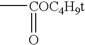 |
| DP2-112 | —CH₃ | —CH₃ | —Cl | —Cl | 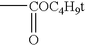 |
| DP2-113 | —C₂H₅ | —C₂H₄NHSO₂CH₃ | —Cl | —Cl | 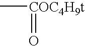 |
| DP2-114 | —CH₃ | 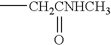 | —Cl | 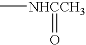 | 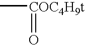 |
| DP2-115 | —H | —C₄H₉t | —Cl | —Cl | 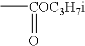 |

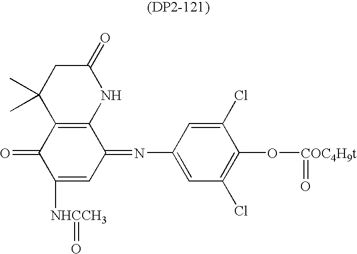

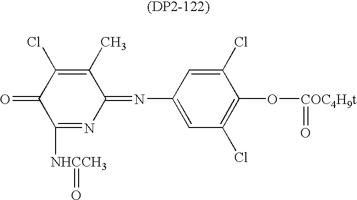

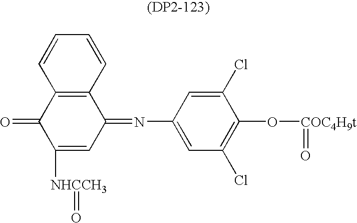

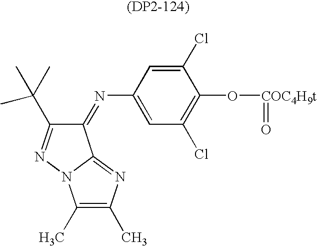

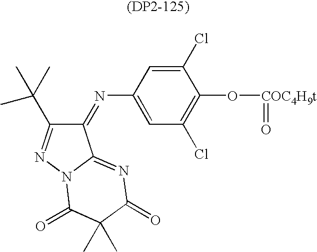

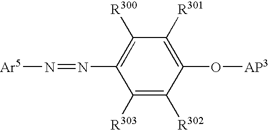

| Compound | | | | | | |
|---|---|---|---|---|---|---|
| No. | R300 | R301 | R302 | R303 | Ar5 | AP3 |
| DP2-131 | —H | —Cl | 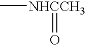 | —H | 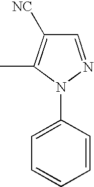 | 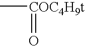 |
| DP2-136 | —H | —Cl | —Cl | —Cl | 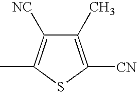 | 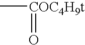 |
| DP2-137 | —H | 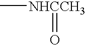 | 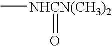 | —H | 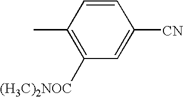 | 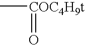 |
| DP2-138 | —H | —Cl | 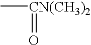 | —H | 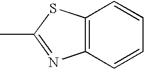 | 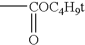 |
| DP2-140 | —H | —Cl | —Cl | —H | 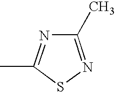 | 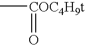 |

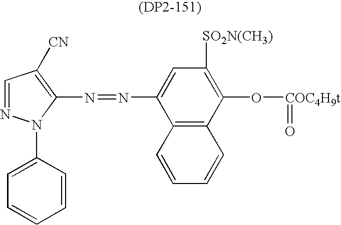

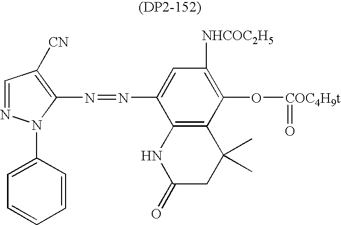

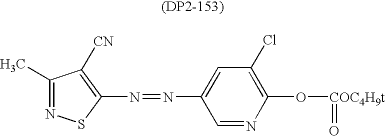

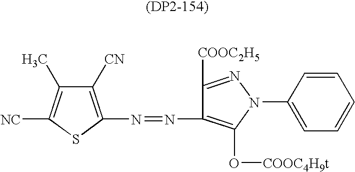

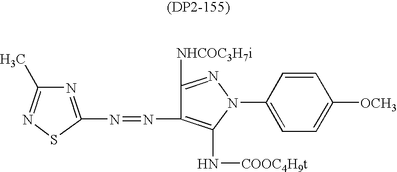

The compounds of the invention represented by the general formula (2) can be synthesized by employing common chemical reactions in sequence. The synthesizing route and synthesizing formulation of a specific compound (DP2-131) will be shown below.

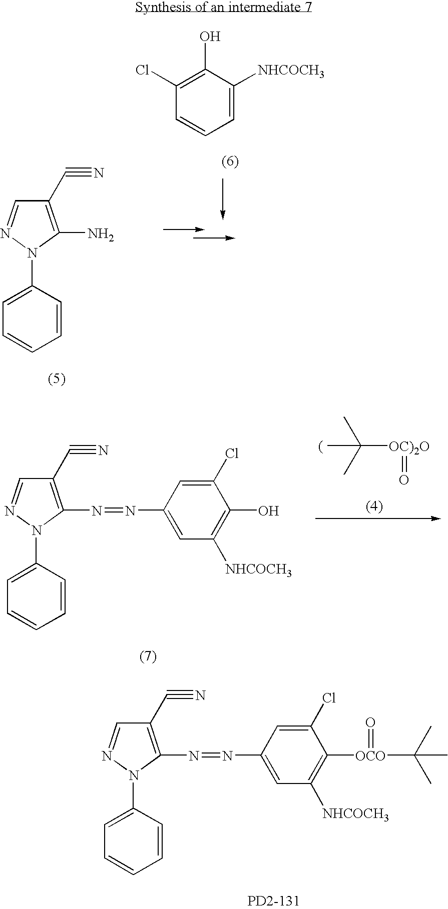

3.7 g (20 mmol) of a compound (5) is dissolved in 40 ml of phosphoric acid, and 1.7 g (25 mmol) of sodium nitrite is added thereto under stirring at 0° C., followed by stirring at 0° C. for 1 hour. Thereafter, 3.7 g of a material (6) is further added to the reaction solution, and the mixture is stirred for 2 hours at 20° C. or lower. This reaction solution is poured into 300 ml of ice water under stirring, and crystals precipitated are collected by filtration, and washed with cold water. The thus-obtained crystals are dried to obtain 5.1 g of the intermediate (7). Yield: 67.1%.

### Synthesis of a Compound of the Invention of PD2-131

40 ml of acetonitrile is added to 3.8 g (10 mmol) of the intermediate (7), 2.4 g (11 mmol) of (4) is added thereto and, under stirring at 20° C., 1.6 ml (11 mmol) of triethylamine is added thereto. After stirring the solution for further 30 minutes, the reaction solution is poured into 200 ml of cold water, and crystals precipitated are collected by filtration and washed with cold water. The thus-obtained crystals are recrystallized from ethyl acetate/hexane to obtain 3.7 g of the compound of the invention of PD2-131. Yield: 77%.

The dye precursor represented by the general formula (2), which is to be used in the information recording layers of the invention for recording a visible image is used preferably in combination with a compound represented by the following general formula (3).

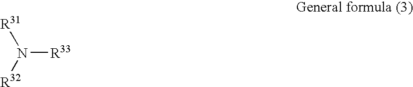

In the general formula (3), R³¹ and R³² each represents a hydrogen atom or an aliphatic group, and R³³ represents a hydrogen atom, an aliphatic group, an aryl group, a hetero ring group, an acyl group, an aromatic oxycarbonyl group, an aliphatic sulfonyl group, an aromatic sulfonyl group, a phosphoryl group, a carbamoyl group, a sulfamoyl group, or the like, provided that R³¹ to R³³ do not represent a hydrogen atom at the same time. R³¹ to R³³ may be connected to each other to form a 5- to 7-membered, nitrogen-containing hetero ring.

The aliphatic group represented by R³¹ to R³³ may be unsubstituted or substituted, and is preferably an alkyl or alkenyl group containing a total of from 1 to 20 carbon atoms, more preferably an alkyl group containing a total of from 1 to 15 carbon atoms. Examples thereof include a methyl group, a butyl group, an ethoxyethoxyethyl group, and a dimethylaminocarbamoylpropyl group.

As the optional substituent in the general formula (3), any one that can substitute may be employed, and examples thereof include those substituents which have been illustrated in the foregoing paragraph describing the substituents (SUB).

The aryl group represented by R³³ may be unsubstituted or substituted, and is preferably an aryl group containing a total of from 6 to 26 carbon atoms, more preferably an aryl group containing a total of from 6 to 21 carbon atoms. Examples thereof include a phenyl group, a 4-chlorophenyl group, a 4-acetamidophenyl group, and a 3-methoxyphenyl group. The hetero ring may be unsubstituted or substituted, and contains preferably a total of from 3 to 24 carbon atoms, more preferably a total of from 4 to 19 carbon atoms. Examples thereof include a 1-piperidino group and a 4-piperidino group. The acyl group may be unsubstituted or substituted, and contains preferably a total of from 2 to 24 carbon atoms, more preferably a total of from 2 to 19 carbon atoms. Examples thereof include an acetyl group, a pivaloyl group, and a 2-phenoxyacetyl group. The aliphatic oxycarbonyl group may be unsubstituted or substituted, and contains preferably a total of from 2 to 24 carbon atoms, more preferably a total of from 2 to 19 carbon atoms. Examples thereof include a methoxycarbonyl group and a (t)-butoxycarbonyl group. The aromatic oxycarbonyl group may be unsubstituted or substituted, and contains preferably a total of from 7 to 27 carbon atoms, more preferably a total of from 7 to 22 carbon atoms. Examples thereof include a phenoxycarbonyl group and a 4-methoxyphenoxycarbonyl group. The aliphatic sulfonyl group may be unsubstituted or substituted, and contains preferably a total of from 1 to 20 carbon atoms, more preferably a total of from 1 to 15 carbon atoms. Examples thereof include a methanesulfonyl group and a nethoxyethanesulfonyl group. The aromatic sulfonyl group may be unsubstituted or substituted, and contains preferably a total of from 6 to 26 carbon atoms, more preferably a total of from 6 to 20 carbon atoms. Examples thereof include a benzenesulfonyl group and a 4-acetylaminobenzenesulfonyl group. The phosphoryl group may be unsubstituted or substituted, and contains preferably a total of from 2 to 24 carbon atoms, more preferably a total of from 2 to 19 carbon atoms. Examples thereof include a dimethoxyphosphoryl group and a diphenoxyphosphoryl group. The carbamoyl group may be unsubstituted or substituted, and contains preferably a total of from 1 to 24 carbon atoms, more preferably a total of from 1 to 19 carbon atoms. Examples thereof include a dimethylcarbamoyl group and a diethylcarbamoyl group. The sulfamoyl group may be unsubstituted or substituted, and contains preferably a total of from 0 to 24 carbon atoms, more preferably a total of from 0 to 19 carbon atoms. Examples thereof include a dimethylsulfamoyl group and a dibutylsulfamoyl group.

In view of the advantages of the invention, R¹³ and R³² each preferably represents an aliphatic group, and R³³ preferably represents an aliphatic group, an aryl group, a hetero ring group, an acyl group, an aliphatic oxycarbonyl group, an aromatic oxycarbonyl group, an aliphatic sulfonyl group, an aromatic sulfonyl group, a phosphoryl group, a carbamoyl group or a sulfamoyl group, more preferably an aliphatic group, an aryl group, a hetero ring group, an acyl group, an aliphatic oxycarbonyl group, an aliphatic sulfonyl group, a carbamoyl group or a sulfamoyl group. Most preferably, R³³ represents an aliphatic group containing an oxycarbonyl bond, a sulfonyl bond, all amido bond, a sulfonamido bond, a urethane bond, a ureido bond or an ether bond, an acyl group, an aliphatic oxycarbonyl group, an aromatic oxycarbonyl group, analiphatic sulfonyl group, an aromatic sulfonyl group, a carbamoyl group or a sulfamoyl group.

Also, R³¹ and R³² may preferably be connected to each other to form a 5- to 7-membered ring (e.g., a pyrrolidine ring or a piperidine ring), and a dimer or more multimer may also be formed.

The content of the compound represented by the general formula (3) is preferably from 0 to 400% by weight, more preferably from 5 to 200% by weight, still more preferably from 10 to 100% by weight, based on the weight of the dye precursor represented by the general formula (2).

Specific examples of the compounds of the invention represented by the general formula (3) include those which are described in Japanese Patent Application No. 2007-109393, and preferred examples thereof are those shown below which, however, do not limit the invention in any way.

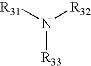

| Compound | | | |
|---|---|---|---|
| No. | R31 | R32 | R33 |
| AM-1 | —CH₃ | —CH₃ | 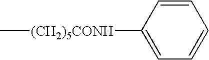 |
| AM-6 | —C₂H₅ | —C₂H₅ | 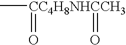 |
| AM-7 | —C₂H₄OC₂H₅ | —C₂H₄OC₂H₅ | —C₂H₄OC₂H₄OC₂H₄OC₂H₅ |
| AM-9 | —C₂H₄OC₂H₅ | —C₂H₄OC₂H₅ | 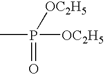 |
| AM-11 | —C₂H₄OC₂H₅ | —C₂H₄OC₂H₅ | —SO₂N(C₂H₅)₂ |
| AM-12 | —C₂H₄OC₂H₅ | —C₂H₄OC₂H₅ | —(CH₂)₃NHCONHC₄H₉ |
| AM-16 | —(CH₂)₃NHSO₂C₄H₉ | —(CH₂)₃COOC₄H₉ | 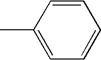 |

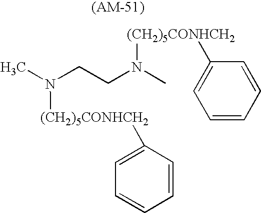

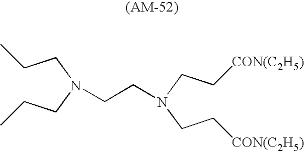

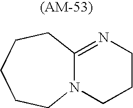

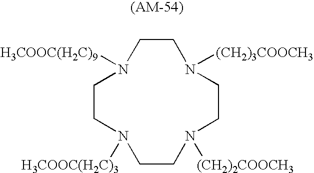

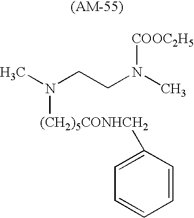

The compounds capable of undergoing reduction of color and/or decoloration by light and/or heat will be described below.

The compounds are so-called dyes, and the dyes have an absorbance of preferably 0.05 or more to a laser light. The dyes may be used alone or in combination of two or more thereof.

The dyes may be any dyes that can undergo reduction of color and/or decoloration by light and/or heat of a laser light, and are not particularly limited. As the dyes, there can be illustrated oxonol dyes, cyanine dyes, azo dyes, phthalocyanine dyes, and pyrromethene dyes.

As such dyes, those dyes described in JP-A-2007-050670 are preferably used. In addition, dyes to be described hereinafter as sensitizing dyes are also preferably used.

As the oxonol dyes, dyes represented by the general formula (1) or (II) described in JP-A-2007-050670 are preferably used.

Preferred oxonol dyes are dyes represented by the following general formula (2-1D_{OX}), which formula is formed by adding a cation to the general formula (2-1D) to be described hereinafter wherein X² and X³ both represent an oxygen atom,

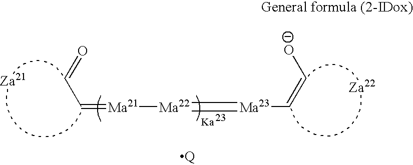

In the formula, Q represents a monovalent cation necessary for neutralizing the electric charge. Za²¹, Za²², and Ma²¹ to Ma²³ are the same as in the general formula (2-1D).

In the general formula (2-1D_{OX}), Ka²³ represents an integer of from 0 to 3. In the case where Ka²³ represents a plural number, plural Ma²¹s and plural Ma²²s may be the same or different.

Q represents a monovalent cation necessary for neutralizing the electric charge. Therefore, 2Q represents a divalent cation. The ion represented by Q is not particularly limited, and may be an ion comprising an inorganic compound or an ion comprising an organic compound. Examples of the cation represented by Q include metal ions such as sodium ion and potassium ion, and onium ions such as a quaternary ammonium ion, an oxonium ion, a sulfonium ion, a phosphonium ion, a selenonium ion, and an iodonium ion.

The cation represented by Q is preferably an onium ion, more preferably a quaternary ammonium ion. Of the quaternary ammonium ions, 4,4′-bipyridinium cations represented by the general formula (I-4) in JP-A2000-52685 and 4,4′-bipyridinium cations disclosed in JP-A2002-59652. With dication compounds such as the 4,4′-bipyridinium cations, Q corresponds to ½ (dication compound).

As preferred oxonol dyes, there are further illustrated dyes represented by the following general formula (2-1DD_{OX}).

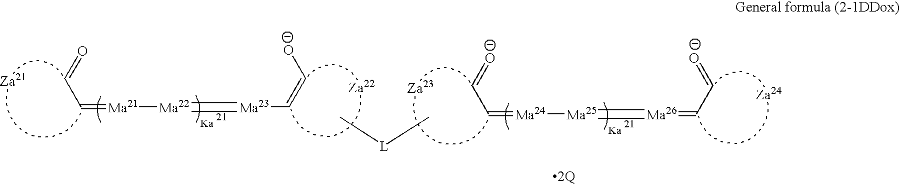

In the formula, Q represents a monovalent cation necessary for neutralizing the electric charge. L represents a divalent linking group which does not form a π conjugation system together with the two bonds. Za²¹, Za²², and Ma²¹ to Ma²³ are the same as defined in the general formula (2-1D_{OX}). Za²³ and Za²⁴ are the same as Za²¹ and Za²². Ka²¹ and Ka²² are the same as Ka²³ in the general formula (2-1D_{OX}).

Examples of the oxonol dye are shown below.

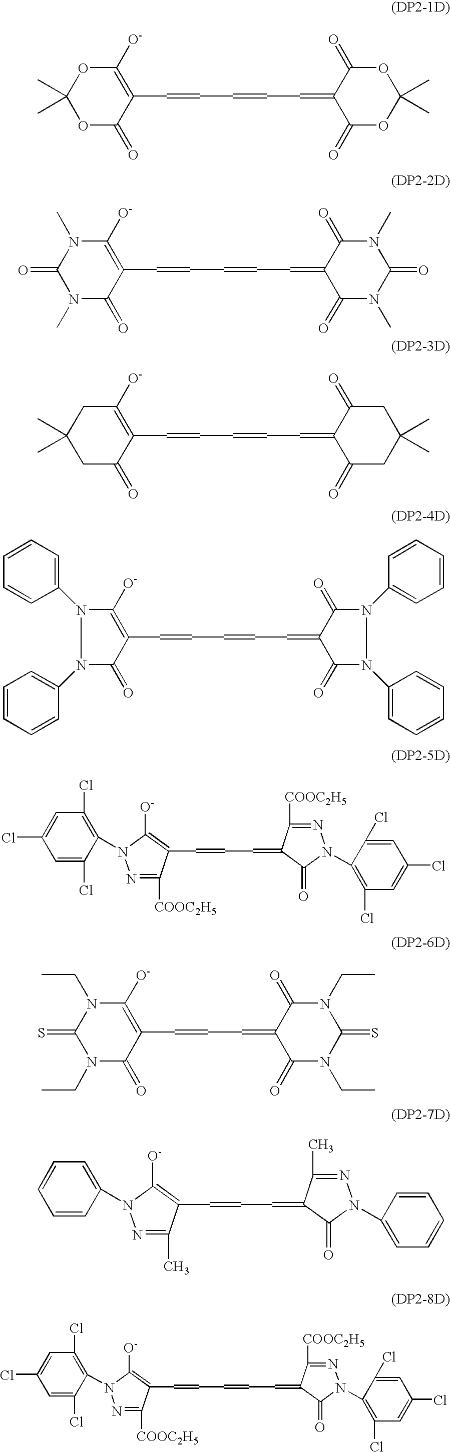

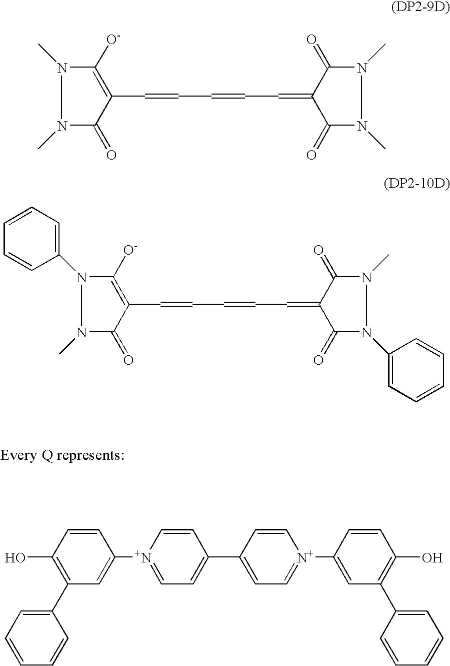

Beside these dyes, oxonol dyes described in JP-A-2007-050678, paragraph Nos. 0047 to 0068 and paragraph Nos. 0091 to 0106 are also usable.

The cyanine dyes are preferably the dyes represented by the general formula (2′) described in JP-A-2007-050678 and, as specific examples thereof, there are illustrated C-1 to C-45 described in JP-A-2007-050678, paragraph Nos. 0115 to 0120. The azo dyes are preferably the dyes represented by the general formula (4″) described in JP-A-2007-050678 and, as specific examples thereof there are illustrated A-1 to A-20 described in SP-A-2007-050678, paragraph Nos. 0135 to 0136. The phthalocyanine dyes are preferably the dyes represented by the general formula (5) described in JP-A-2007-050678 and, as specific examples thereof, there are illustrated 1-1 to I-45 described in JP-A-2007-050678, paragraph Nos. 0146 to 0149. The pyrromethene dyes are preferably the dyes represented by the general formula (Pa) described in JP-A-2007-050678 and, as specific examples thereof, there are illustrated those dyes which are described in patent documents such as JP-A-2007-050678, paragraph No. 0157.

“Heat” used herein in the phrase of “the group capable of being decomposed by heat” means heat to be generated by light-heat conversion upon irradiation with a laser light.

In the invention, a laser light irradiated by a laser is absorbed and converted to heat, and the dye precursor is converted to the dye by the heat to form a color, thus a visible image being obtained. With dye precursors which do not absorb or only slightly absorb the wavelength of light emitted from a laser to be used, addition of a dye having an absorption at the oscillation wavelength of a laser to be used (corresponding to “sensitizing dye” to be described hereinafter) is required, though such addition is not required with dye precursors having an absorption in the wavelength of a laser to be used. As the dye, any dye that has an absorption at the oscillation wavelength of light emitted from a laser may be employed. Preferred dyes are those which are represented by the following general formulae (1-11D) to (1-13D), and (2-1D) to 2-3D), and more preferred dyes are those which are represented by the general formulae (1-11D) to (1-13D), and (2-1D). In addition, dyes of formula (II) and dyes of the general formula (5) described in JP-A-2007-50678 are also preferably used.

The general formulae (1-11D) to (1-13D) and (2-1D) to (2-3D) show the structures of dyes formed from the dye precursors of the general formulae (1-11) to (1-13) and (2-1) to (2-3), respectively.

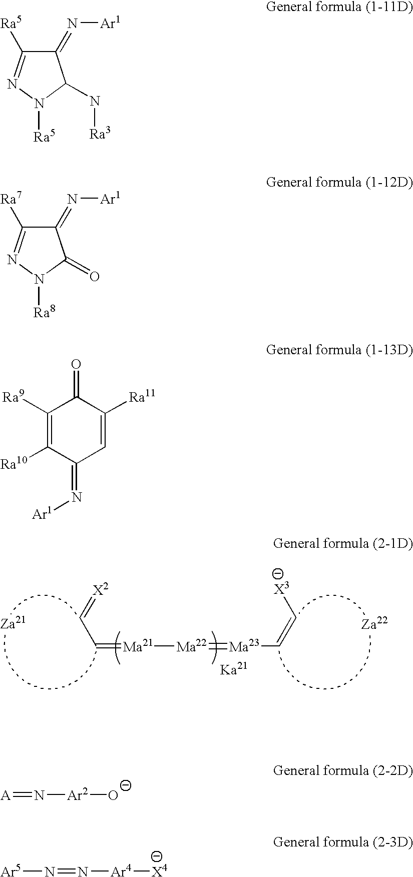

In the general formulae (1-11D) to (1-13D) and (2-1D) to (2-3D), Ra³, Ra⁵to Ra¹¹, Ar¹, Za²¹, Za²², Ma²¹ to Ma²³, Ka²¹, X², X³, A, Ar², Ar⁴, Ar⁵ and X⁴ are the same as defined in the general formulae (1-11) to (1-13) and (2-1) to (2-3).

In view of advantages of the invention, the amount of the dye to be used is preferably from 0 to 200% by weight, more preferably from 10 to 100% by weight, based on the weight of (1) or (2), though depending upon the absorption density of the dye precursor of the general formula (1) or (2) at the oscillation wavelength of light emitted from a laser to be used.

### [Information Recording Layer for Recording a Visible Image]

The optical recording medium of the invention contains, in the visible information recording layer, at least one dye precursor capable of forming a dye by heat or by both heat and aerial oxidation reaction or forming a dye whose maximum absorption wavelength has been changed. When irradiated with a laser light, the dye absorbs the laser light to cause light-heat conversion, thus heat being generated. The dye precursor is decomposed by the generated heat to form a dye having a new absorption in the visible region in the laser light-irradiated areas and the peripheries thereof. With dyes having a low thermal decomposition temperature, however, there exists a region where the formed dyes might be decomposed too. With dye precursors not having any absorption at the wavelength of laser light, a dye having a corresponding absorption must be added in order to cause light-heat conversion. As is described above, visible information can be formed in the visible information recording layer by producing a difference in color tone or hue between areas which have undergone coloration or change of color by irradiation with a laser light and areas which have not been irradiated with the laser light.

The visible information recording layer contains the dye precursor preferably as a major component. The term “containing as a major component” as used herein means that the content of the dye precursor in the visible information recording layer is 40% by weight or more based on the weight of all the solid components in the information recording layer. The content of the dye precursor in the visible information recording layer is preferably 50% by weight or more, more preferably from 60 to 100% by weight. However, in the case where the dye precursor does not have an absorption at the oscillation wavelength of laser light as has been described hereinbefore, addition of a dye having an absorption corresponding to the laser light wavelength (such dye being referred to as “sensitizing dye” in this specification) is required. The visible information recording layer can contain other dye than the sensitizing dye. In order to form a visible image having a high contrast, excellent visibility, and a high fastness, the dye component incorporated in the visible information recording layer preferably has a color which is in a complementary relation with, or is largely different in absorption wavelength from, a dye to be formed by coloration or by discoloration.

The sensitizing dye has an absorbance of preferably 0.5 or more (more preferably from 0.1 to 1.0) for a laser light of a wavelength ranging from 400 to 850 nm. Incorporation of the sensitizing dye having such absorbance in the visible information recording layer serves to conduct sufficient light-heat conversion upon irradiation with the laser light, whereby a visible image such as letters, images, picture patterns or the like having good visibility can be recorded with the dye precursor.

The visible information recording layer can be formed by coating a coating solution which is prepared by dissolving the dye precursor (and the sensitizing dye) in a solvent. As the solvent, various solvents that can be used for a coating solution for forming a recording layer to be described hereinafter can be used. Details about other additives and coating methods are as will be described with respect to the recording layer.

The thickness of the visible information recording layer is preferably from 0.01 to 200 μm, more preferably from 0.05 to 150 μm, still more preferably from 0.1 to 50 μm. The ratio of the thickness of the visible information recording layer to the thickness of the digital information recording layer (thickness of the visible information recording layer/thickness of the digital information recording layer) is preferably from 1/100 to 100/1, more preferably from 1/10 to 10/1.

The visible information to be recorded on the visible information recording layer means visually recognizable information and includes all visible information such as a row of letters, picture patterns and figures. The letter information includes: authorized user-indicating information; information indicating a valid period of use; information indicating a number of times that the medium can be used; rental information; resolution-indicating information; layer-indicating information; user-indicating information; copyright owner information; copyright number information; manufacturer information; production date information; sales date information; store or retailer information; information indicating set number for use; region-indicating information; language-indicating information; information indicating applications; product user information; and use number information.

### <Layer Structure>

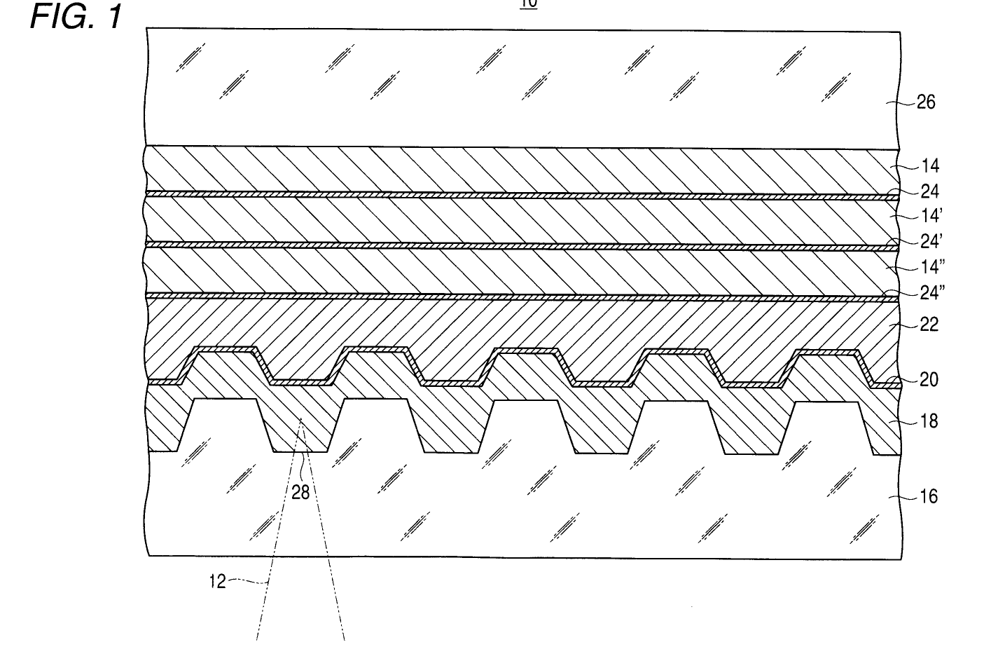

The optical recording medium of the invention can have a structure having, for example, a first substrate, a recording layer capable of recording and/or reproducing information by irradiation with a laser light, a reflective layer, a visible information recording layer, and a second substrate in this order. The optical recording medium of the invention may have a structure in which reflective layers are interleaved with visible information recording layers. However, the optical recording medium of the invention is not particularly limited as to its layer structure as long as it has a visible information recording layer on a substrate and the visible information recording layer contains the dye precursor and, therefore, the optical recording medium can have various layer structures. One example of the optical recording medium of the invention is shown in FIG. 1 (schematic cross-sectional view).

An optical recording medium 10 shown in FIG. 1 has a first substrate 16, a digital information recording layer 18 formed on the first substrate 16, a first reflective layer 20 formed on the digital information recording layer 18, an adhesive layer 22 formed on the first reflective layer 20, a second reflective layer 24 formed on the adhesive layer 22, the visible information recording layer 14 formed on the second reflective layer 24, and a second substrate 26 formed on the visible information recording layer 14. The type of the optical recording medium may be any of a read-only type, a recordable type, and a rewritable type, with a recordable type being preferred. With the recordable type, the recording may be performed by any method such as a phase change method, a magneto optic method, and a dye type method, with a dye type method being preferred.

As to layer structure of the optical recording medium of the invention, there can be illustrated the following structures.

(1) A first layer structure comprises, as shown in FIG. 1, a first substrate 16 having formed thereon a digital information recording layer 18, a first reflective layer 20, an adhesive layer 22, and a second reflective layer 24 in this order, with the second reflective layer 24 having provided thereon a visible information recording layer 14 and a second substrate 26.
(2) A second layer structure (not shown) comprises a first substrate 16 having formed thereon a digital information recording layer 18, a first reflective layer 20, an adhesive layer 22 in this order, with the adhesive layer 22 having provided thereon a visible information recording layer 14 and a second substrate 26.
(3) A third layer structure (not shown) comprises a first substrate 16 having formed thereon a digital information recording layer 18, a first reflective layer 20, a protective layer, and an adhesive layer 22 in this order, with the adhesive layer 22 having provided thereon a visible information recording layer 14 and a second substrate 26.
(4) A fourth layer structure (not shown) comprises a first substrate 16 having formed thereon a digital information recording layer 18, a first reflective layer 20, a first protective layer, an adhesive layer 22, and a second protective layer in this order, with the second protective layer having provided thereon a visible information recording layer 14 and a second substrate 26.
(5) A fifth layer structure comprises a first substrate 16 having formed thereon a digital information recording layer 18, a first reflective layer 20, a first protective layer, an adhesive layer 22, a second protective layer, and a second reflective layer 24 in this order, with the second reflective layer 24 having provided thereon a visible information recording layer 14 and a second substrate 26.

Additionally, it should be noted that the first to fifth layer structures are mere examples, and the structure is not limited only to the above-described order. Part of the layers may be exchanged, and part of the layers may be omitted. Further, each layer may have a monolayer structure or a multi-layer structure.

When the optical recording medium of the invention is CD-R, it preferably has a structure comprising a transparent disc-like first substrate 16 of 1.2±0.2 mm in thickness on which a pregroove 28 of from 1.4 to 1.8 μm in track pitch (see FIG. 1) is formed, having formed thereon a digital information recording layer 18, a first reflective layer 20, a protective layer, an adhesive layer 22, a second reflective layer 24, a dye-containing visible information recording layer 14, and a second substrate 26 in this order. Also, in the case of applying the optical recording medium of the invention to DVD-R, the following two embodiments are preferred.

(1) An optical information recording medium wherein two layered bodies, each comprising a transparent disc-like first substrate 16 of 0.6±0.1 mm in thickness on which a pregroove 28 of from 0.6 to 0.9 μm in track pitch is formed, having formed thereon a digital information recording layer 18 and a light-reflecting layer, are laminated one over the other with each digital information recording layer 18 inside to acquire a thickness of 1.2±0.2 mm, with a visible information recording layer 14 being provided on at least one of the first substrates 16.
(2) An optical information recording medium wherein a layered body comprising a transparent disc-like first substrate 16 of 0.6±0.1 mm in thickness on which a pregroove 28 of from 0.6 to 0.9 μm in track pitch is formed, having formed thereon a digital information recording layer 18 and a light-reflecting layer, is laminated on a transparent, disc-like protective substrate having the same shape as that of the disc-like first substrate 16 of the layered body with the digital information recording layer 18 inside to acquire a thickness of 1.2±0.2 mm, with a visible information recording layer 14 being provided on at least one of the substrates. Additionally, with the DVD-R type optical information recording media, a protective layer may further be provided on the light-reflecting layer.

Now, individual layers and substrates will be described one by one below.

### <Digital Information Recording Layer>

The digital information recording layer in the optical recording medium of the invention is a layer which can record and/or reproduce information by irradiation with a laser light. The digital information recording layer is a layer on which code data (coded information) such as digital information are to be recorded. The type of the layer is not particularly limited and includes a rewritable type (dye-containing rewritable type being preferred), a phase change type, and a magneto optic type, with a dye-containing type being preferred.

Specific examples of dyes to be incorporated in the dye-containing type digital information recording layer include cyanine dyes, oxonol dyes, metal complex-containing dyes, azo dyes, and phthalocyanine dyes. In addition, dyes described in official gazettes such as JP-A-4-74690, JP-A-8-127174, JP-A-11-53758, JP-A-11-334204, JP-A-11-334205, JP-A-1-334206, SP-A-11-334207, JP-A-2000-43423, JP-A-2000-108513, and JP-A-2000-158818 can preferably be used.

The recording layer can be formed by dissolving the recording substance such as a dye in an appropriate solvent together with a binder to prepare a coating solution, coating this coating solution on a substrate to form a coated film, and then drying the film. The concentration of the recording substance in the coating solution is in the range of generally from 0.01 to 15% by weight, preferably from 0.1 to 10% by weight, more preferably from 0.5 to 5% by weight, most preferably from 0.5 to 3% by weight.

The recording layer can be formed by, for example, a vacuum deposition method, a sputtering method, a CVD method or a solvent coating method. Of these methods, a solvent coating method is preferred. In this case, the recording layer can be formed by dissolving the dye and, further, as needed, a quencher, a binder, etc. in a solvent to prepare a coating solution, and then coating this coating solution on the surface of a substrate to form a coated film, and drying the coated film.

As the solvent for the coating solution, there can be illustrated esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, isopropanol, in-butanol, and diacetonalcohol; fluorine-containing solvents such as 2,2,3,3-tetrafluoropropanol; and glycol ethers such as ethylene glycol monomethyl ether, ethylene glycol monoethyl ether, and propylene glycol monomethyl ether.

The above-mentioned solvents can be used alone or in combination of two or more thereof in consideration of the solubility of the dye to be used. To the coating solution may further be added various additives such as an antioxidant, a UV absorbent, a plasticizer, and a lubricant according to the purpose.

In the case of using a binder, examples of the binder include natural organic high-molecular substances such as gelatin, cellulose derivatives, dextran, rosin, and rubber; and synthetic organic high polymers such as hydrocarbon resins (e.g., polyethylene, polypropylene, polystyrene, and polyisobutylene), vinyl resins (e.g., polyvinyl chloride, polyvinylidene chloride, and polyvinyl chloride-polyvinyl acetate copolymer), acryl resins (e.g., polymethyl acrylate and polymethyl methacrylate), polyvinyl alcohol, chlorinated polyethylene, epoxy resin, butyral resin, rubber derivatives, and initial condensates of thermo-setting resins (e.g., phenol-formaldehyde resin).

In the case of using the binder together with other components as a material for the recording layer, the amount of the binder is in the range of generally from 0.01- to 50-fold amount, preferably from 0.1- to 5-fold amount based on the weight of the dye.

As a method for coating the solvent, there can be illustrated a spray coating method, a spin coating method, a dip coating method, a roll coating method, a blade coating method, a doctor roll coating method, and a screen printing method. The recording layer 18 may be a single layer or plural layers. The thickness of the recording layer 18 is in the range of generally from 10 to 500 nm, preferably from 15 to 300 nm, more preferably from 20 to 150 nm.

Various anti-fading agents may be incorporated in the recording layer for improving light fastness of the recording layer. As the anti-fading agent, singlet oxygen quenchers are generally used. As such singlet oxygen quenchers, those quenchers which have so far been known in publications such as patent specifications can be utilized. The amount of the anti-fading agent such as the singlet oxygen quencher is in the range of usually from 0.1 to 50% by weight, preferably from 0.5 to 45% by weight, more preferably from 3 to 40% by weight, particularly preferably from 5 to 25% by weight, based on the weight of the dye.

Specific examples of materials constituting the phase change type recording layer include a Sb—Te alloy, a Ge—Sb—Te alloy, a Pd—Ge—Sb—Te alloy, an Nb—Ge—Sb—Te alloy, a Pd—Nb—Ge—Sb—Te alloy, a Pt—Ge—Sb—Te alloy, a Co—Ge—Sb—Te alloy, an In—Sb—Te alloy, an Ag—In—Sb—Te alloy, an Ag—V—In—Sb—Te alloy, and an Ag—Ge—In—Sb—Te alloy, The thickness of the phase change type recording layer 18 is preferably from 10 to 50 nm, more preferably from 15 to 30 nm. The phase change type recording layer can be formed by a gas phase film deposition method such as a sputtering method or a vacuum deposition method.

### <First Substrate>

The first substrate 16 in the optical recording medium shown in FIG. 1 can be formed by using a material selected from among various materials having conventionally been used as a substrate for an optical recording medium. As materials for the first substrate 16, there can be illustrated, for example, glass, polycarbonate, acryl resins such as polymethyl methacrylate, vinyl chloride series resins such as polyvinyl chloride and vinyl chloride copolymers, epoxy resins, amorphous polyolefins, and polyesters. These may be used in combination thereof as needed. Additionally, these materials can be used in a film form or as a first substrate 16 having some rigidity. Of the above-described materials, polycarbonate is preferred in view of moisture resistance, dimensional stability, and price.

The thickness of the first substrate 16 is preferably from 0.1 to 1.2 mm, more preferably from 0.2 to 1.1 mm.

For the purpose of improving planarity, enhancing adhesion, and preventing changes in the properties of the recording layer 18, an undercoat layer may be provided on the surface side (on which the pregroove 28 is formed) of the first substrate 16 on the side on which the recording layer 18 is provided.

Materials for the undercoat layer include, for example, high molecular substances such as polymethyl methacrylate, acrylic acid-methacrylic acid copolymer, styrene-maleic acid anhydride copolymer, polyvinyl alcohol, N-methylolacrylamide, styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene, and polycarbonate; and surface modifying agents such as a silane coupling agent. The undercoat layer can be formed by dissolving or dispersing the above-described substance in an appropriate solvent to prepare a coating solution, and coating this coating solution on the surface of the first substrate 16 by a coating method such as a spin coating method, a dip coating method or an extrusion coating.

The thickness of the undercoat layer is in the range of generally from 0.005 to 20 μm, preferably from 0.01 to 10 μm.

### <First Reflective Layer>

As is shown in FIG. 1, a first reflective layer 20 may be provided in some cases adjacent to the recording layer 18 for the purpose of enhancing the reflectivity upon reproduction of information. The light-reflecting substance forming the first reflective layer 20 is a substance having a high reflectivity for a laser light, and can be exemplified by metals and semi-metals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi; and stainless steel. These substances may be used alone or in combination of two or more thereof or as an alloy thereof. The first reflective layer 20 can be formed on the first substrate 16 or the recording layer 18 by sputtering or ion-plating the light-reflecting substance. The thickness of the first reflective layer 20 is in the range of generally from 10 to 300 nm, preferably from 50 to 200 nm.

### <Adhesive Layer>

As is shown in FIG. 1, an adhesive layer 22 can be formed in order to enhance adhesion between the first reflective layer 20 and the second substrate 26.

As a material for constituting the adhesive layer 22, photo-curable resins are preferred. In particular, photo-curable resins having a small curing shrinkage are preferred in order to prevent warpage of the disc. As such photo-curable resin, there can be illustrated, for example, UV-curable resins (UV-curable adhesives) such as “SD-640” and “SD-347” manufactured by Dainippon Ink & Chemicals, Inc. The thickness of the adhesive layer 22 is in the range of preferably from 1 to 1,000 μm, more preferably from 5 to 500 μm, particularly preferably from 10 to 100 μm in order to impart sufficient elasticity.

### <Second Substrate>

As is shown in FIG. 1, a second substrate 26 (protective substrate) can be provided for protecting the visible information recording layer 14. The second substrate 26 can be formed by using the same material as that used for the first substrate 16,

### <Protective Layer>

In some cases, a protective layer is provided for physically and chemically protecting the first reflective layer 20 or the recording layer 18. Additionally, in an embodiment where the same structure as in the case of manufacturing DVD-R type optical recording medium is employed, that is, in an embodiment of the structure that two substrates (including the case where one of them is the second substrate 26) are laminated with the recording layer 18 inside, formation of the protective layer is not necessarily required.

Examples of the materials to be used for the protective layer include inorganic substances such as ZnS, ZnS—SiO2, SiO, SiO₂, MgF₂, SnO₂, and Si₃N₄; and organic substances such as thermoplastic resins, thermosetting resins, and UV curable resins.

In the case of using the thermoplastic resin or thermosetting resin, the protective layer can also be formed by dissolving it in an appropriate solvent to prepare a coating solution, coating this coating solution, and drying the coated film. With the UV curable resin, the protective layer can also be formed by coating it as such or as a solution prepared by dissolving it in an appropriate solvent, and irradiating the coated film with UV light. To the coating solution may further be added various additives such as an antistatic agent, an antioxidant, and a UV absorbent according to the purpose. The thickness of the protective layer is in the range of generally from 0.1 μm to 1 mm.

In addition, the optical recording medium of the invention can also be used as a so-called reproduction-only optical information recording medium having recorded areas (pits) where reproducible information is recorded by laser light.

### [Method for Recording Visible Image]

A first method of the invention for recording visible information (hereinafter referred to as “recording method I”) is a method for recording visible information on the visible information recording layer of the optical recording medium of the invention and is a method of recording the visible information using the same laser light as the laser light used for recording digital information on the digital information recording layer.

A second method of the invention for recording visible information (hereinafter referred to as “recording method II”) is a method for recording visible information on the visible information recording layer of the disc-like optical recording medium of the invention and is a method of recording the visible information by using a laser light oscillating in the radius direction of the optical recording medium and being irradiated plural times along about the same locus. Additionally, in the recording method II too, the visible information is recorded by using preferably the same laser light as that used for the digital information recording layer as is the same in the recording method I.

Hereinafter, the recording methods I and II are in some cases inclusively referred to as the recording method of the invention.

According to the recording method I, visible information can be recorded by using the same laser light (laser light 12 in FIG. 1) as the laser light used for recording digital information on the digital information recording layer (laser light 12 in FIG. 1), and hence one laser light source can be shared in a recording apparatus. Thus, hardware resource of the recording apparatus can be minimized and, in addition, a general user can easily record an image by employing the recording apparatus. Further, since the optical recording medium of the invention contains a dye generated from the dye precursor in the visible information recording layer, there is provided an advantage that an image having a high contrast and an excellent visibility can be formed. Recording of visible information such as an image on the visible information recording layer of the optical recording medium of the invention is most preferably conducted by the visible information recording method of the invention, but the recording method is not limited only to that.

In the recording method of the invention, recording of visible information such as an image on the visible information recording layer and recording of optical information on the digital information recording layer can be conducted by using one optical disc drive (recording apparatus) capable of recording on both layers. In the case of using one optical disc drive as described above, recording on one of the visible information recording layer and the digital information recording layer is first conducted and, after turning over the disc, recording on the other layer can be conducted. As an optical disc drive having the function of recording visible information on the visible information recording layer, there can be used optical disc drives described in, for example, JP-A-2003-203348 and JP-A-2003-242750.

Also, upon recording visible information on the visible information recording layer, some recording apparatus can record a visible image by tracking both the optical recording medium and a laser pickup along a tracking groove formed on the visible information recording layer to relatively move along the surface of the optical recording medium, and irradiating toward the visible information recording layer a laser light modulated according to image data of letters or a picture pattern to be formed in synchronous with the relative movement. Such constitution is described in, for example, JP-A-2002-203321.

In common digital data recordings it is common to irradiate with a laser light once in an about elliptical form. In general, upon forming pits on a dye recording layer, it is regarded as important to form pits having sufficient reflectivity and modulation degree for a drive to recognize, and hence, as a dye for the dye recording layer, those dyes are selected which can provide sufficient reflectivity and modulation degree by the one-time laser light irradiation.

In contrast, in recent years, the system described in JP-A-2002-203321, etc. has been proposed. In this system, visible information such as an image is recorded on a dye-containing, information recording layer by irradiating plural times with a laser light along about the same locus. With common optical discs, the position for forming pits are fixed in the radius direction, and hence the laser light never oscillates in the radius direction of the optical disc whereas, in the above-described system, the laser light oscillates in the radius direction of the optical disc and is irradiated plural times along about the same locus to record visible information. Dyes to be used in the invention are all appropriate for the system, and visible information having a high contrast, a high distinctness and an excellent light fastness can be formed by the aforesaid recording system.

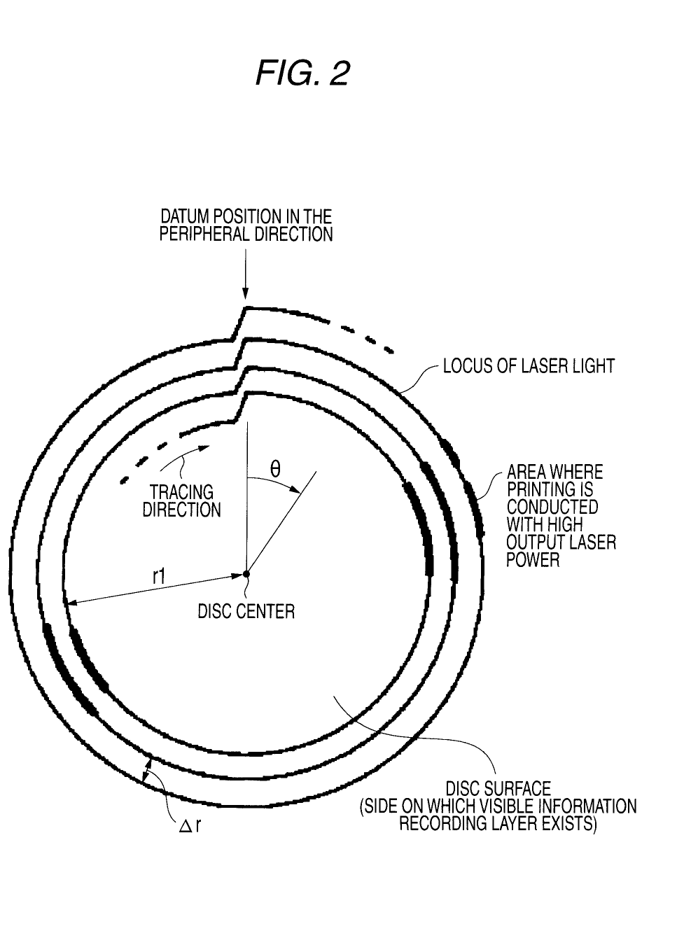

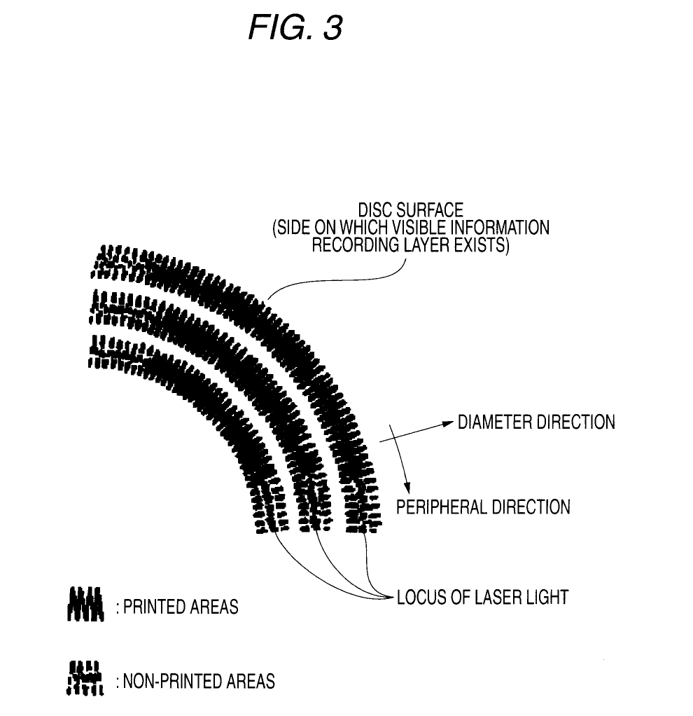

The image-forming method of the invention will be described in detail below by reference to FIGS. 2 and 3.

FIG. 2 shows the locus of a laser light irradiated for forming an image.

First, as is shown in FIG. 2, a laser light source is positioned at the radius position at which image formation initiates on the inner periphery side, and then the peripheral direction position, θ, is detected, and the laser power is changed to a predetermined high-power output (a level at which the information recording layer undergoes change in visible light properties; e.g., 1 mW or more) at each image-forming position in the peripheral direction indicated by image data with respect to the radius position. Thus, visible light properties of the information recording layer are changed (e.g., discoloration) at the position irradiated with the high-output laser light to conduct image formation.

Thereafter, when the optical disc makes one revolution and returns the datum position in the peripheral direction, the light source is migrated in the outer peripheral direction by a predetermined pitch of Δr, and the laser power is changed to a predetermined high output at each image-forming position in the peripheral direction indicated by the image data with respect to the radius position. After this, the operation is repeated with successively migrating in the peripheral direction by a predetermined pitch of Δr at every rotation, thus an image being formed. FIG. 2 shows the locus of a laser light on the surface of the optical disc (surface on the side of the visible information recording layer; hereinafter also referred to as “label surface”) in the image-forming operation. The laser power is changed to the high output at the areas drawn by thick lines to conduct image formation. FIG. 3 shows an enlarged view of the locus of the laser light in the portion drawn by the thick line. As is shown in FIG. 3, an image is formed by oscillating a laser light in the radius direction of the optical disc and irradiating the laser light plural times along about the same locus. The oscillation width and the laser light-irradiating time in about the same locus are set for each recording apparatus.

In the above-described image-forming method, scanning is not conducted at a radius position where no image-forming positions exist, and the laser light source is migrated at one stroke to a radius position where next image-forming positions exist to conduct image formation. When the pitch of Δr is too large, even an image which is to be originally formed in a continuous pattern in the diameter direction is formed with spaces therein. Such spaces can be made inconspicuous by reducing the pitch of Δr, which, however, leads to an increase in rotation times necessary for forming the image on the entire label surface, resulting in a prolonged time for image formation. In the apparatus described in JP-A-2002-203321, a tracking actuator is driven by an oscillating signal (e.g., sign wave or triangular wave) generated from an oscillation signal-generating circuit upon formation of an image to oscillate an objective lens in the disc diameter direction. Thus, the laser light oscillates in the disc diameter direction to conduct formation of an image with no spaces (or small spaces) therein even when the pitch of Δr is comparatively large. The frequency of the oscillation signal can be set to, for example, about several kHz. Also, the pitch of Δr can be set to, for example, from about 50 to about 100 μm.

As to details on the image-forming method, reference may be made to JP-A-2002-203321.

A recording apparatus for recording optical information (digital information) on the recording layer has at least a laser pickup which emits a laser light and a rotating mechanism for rotating the optical recording medium, and can record information on and reproduce information from the recording layer by emitting a laser light from the laser pickup toward the recording layer of the rotating optical recording medium. The constitution of such recording apparatus itself is well known.

Next, recording of information on the recording layer (digital information) will be described below. In the case where the recording layer is of a dye type, a laser light is emitted from the laser pickup while rotating the unrecorded optical recording medium at a predetermined linear velocity. The dye in the recording layer absorbs the emitted light to locally cause an increase in temperature and produce desired pits, thus optical properties of the area being changed to record information.

In forming one pit, the recording waveform of the laser light may be a row of pulses or may be one pulse. The proportion to the length of actual recording (length of pit) is of importance.

The pulse width of the laser light is in the range of preferably from 20 to 95%, more preferably from 30 to 90%, still more preferably from 35 to 85%, based on the length of actual recording. Here, in the case where the recording waveform is a row of pulses, the sum of them falls within the above-described range.

The power of the laser light varies depending upon recording linear velocity and, in the case where the recording linear velocity is 3.5 m/s, the power is in the range of preferably from 1 to 100 mW, more preferably from 3 to 50 mW, still more preferably from 5 to 20 mW. When the recording linear velocity becomes twice that, the preferred ranges of the power become 2^{1/2}-fold amounts, respectively. Also, in order to enhance recording density, NA of the objective lens to be used in the pickup is preferably 0.55 or more, more preferably 0.60 or more.

In the invention, a semi-conductor laser having an oscillation wavelength in the range of from 350 to 850 nm can be used for recording.

Next, the phase change type recording layer will be described below. The phase change type recording layer is constituted by the aforesaid materials and can repeatedly undergo phase change between a crystal phase and an amorphous phase by irradiation with a laser light. Upon recording information, a focused laser light pulse is irradiated for a short time to partially melt the phase change recording layer. The molten area is quenched by diffusion of heat and solidifies to form an amorphous-state recording mark. Upon erasing the mark, the recorded mark portion is irradiated with the laser light to heat to a temperature not higher than the melting point of the recording layer and not lower than the crystallizing temperature of the recording layer, and is then gradually cooled to crystallize the amorphous-state recorded mark and restore to the original unrecorded state.

### EXAMPLES

The present invention will be described in more detail by reference to Examples. However, the invention is not limited only to the embodiments shown in the Examples.

### Example 1

### [1] Molding of First Substrate (Substrate on the Digital Information Recording Side)

A first substrate of 0.6 mm in thickness, 15 mm in inside diameter, and 120 mm in diameter having a spiral groove (depth: 130 nm; width: 300 nm; track pitch: 0.74 μm) on one side thereof is molded from a polycarbonate resin by injection molding.

### [2] Formation of a Recording Layer on the Digital Information Recording Side

Thereafter, the following two oxonol dyes (DYE-1, DYE-2), each in an amount of 1.5 g, are dissolved in 100 ml of 2,2,3,3-tetrafluoro-1-propanol to prepare a coating solution, and this coating solution is coated by a spin coating method on the side of the first substrate on which side the spiral groove has been formed, thus a digital information recording layer of 30 nm in thickness being formed.

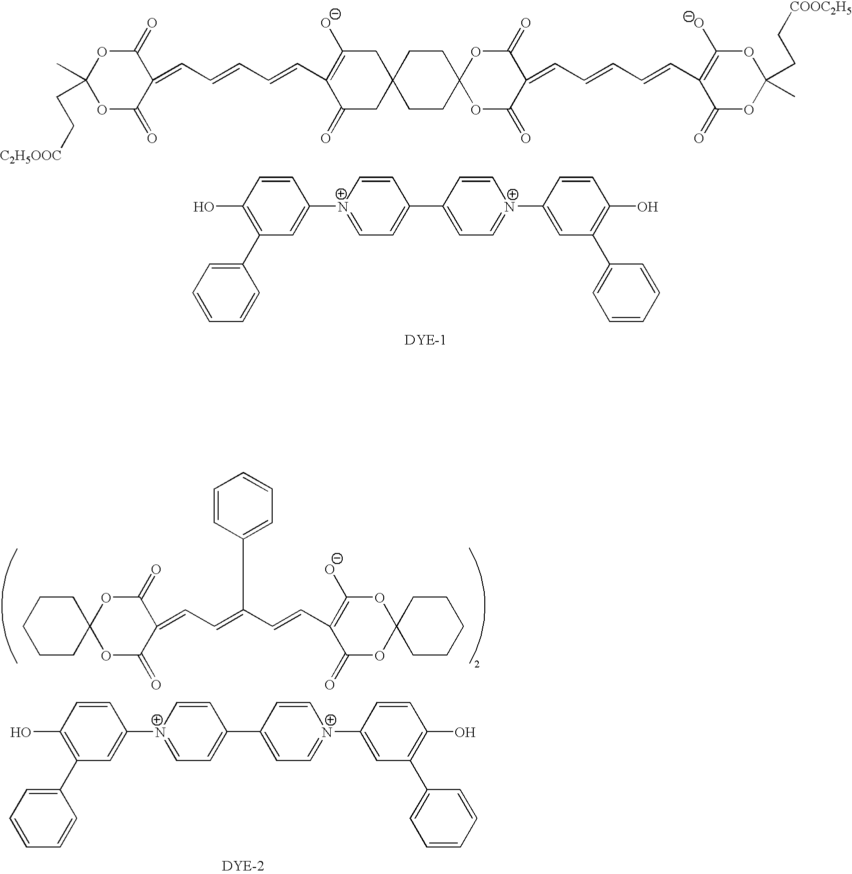

### [3] Formation of a Reflective Layer on the Recording Layer on the Digital Information-Recording Side

Next, a 150-nm thick reflective layer (Ag: 98.1 parts by weight; Pd: 0.91 part by weight; Cu: 1.0 part by weight) is formed on the recording layer on the digital information-recording side by DC sputtering method in an atmosphere of Ar.

### [4] Formation of a First Protective Layer

Next, a UV curable resin (SD318; manufactured by Dainippon Ink & Chemical Industries, Inc.) is coated on the reflective layer on the digital information-recording side by spin coating method, and then the coated layer is irradiated with UV rays to cure, thus a first protective layer of 10μ in thickness being prepared. A first disc is prepared by the above-described steps.

### [5] Molding of a Second Substrate (Substrate on the Label Side)

A second substrate of 0.54 mm in thickness, 15 mm in inside diameter, and 120 mm in diameter both surfaces of which are plane is molded from a polycarbonate resin by injection molding.

### [6] Formation of a First Visible Information Recording Layer

Next, in order to form a first visible information recording layer, a coating solution for forming the first visible information recording layer is prepared by dissolving 1.5 g of a dye precursor (DP1-1) capable of forming magenta color by heat and 0.5 g of a sensitizing dye (DP2-8D) capable of absorbing laser light to undergo thermal decomposition in 100 ml of 2,2,3,3-tetrafluoro-1-propanol. Then, the coating solution for forming the first visible information recording layer is coated on the second substrate by the spin coating method to form the first visible information recording layer of 100 nm in thickness (14 in FIG. 1).

### [7] Formation of a First Reflective Layer

Next, a reflective layer (Ag) (24 in FIG. 1) of 10 nm in film thickness is formed on the first visible information recording layer by a DC sputtering method in an Ar atmosphere.

### [8] Formation of a first UV adhesive layer

Next, a first UV adhesive layer of 20 gm in thickness is formed by coating a UV ray-curable resin (SD640; manufactured by Dainippon Ink & Chemicals, Inc.) by a spin coating method, and then irradiating with UV rays to cure.

### [9] Formation of a Second Visible Information Recording Layer

Next, in order to form a second visible information recording layer, a coating solution for forming the second visible information recording layer is prepared by dissolving 1.5 g of a dye precursor (DP1-51) capable of forming a cyan color by heat into 100 ml of 2,2,3,3-tetrafluoro-1-propanol. Then, this coating solution for forming the second visible information recording layer is coated on the first UV adhesive layer by the spin coating method to form the 100-nm thick second visible information layer (14′ in FIG. 1).

### [10] Formation of a Second Reflective Layer

Next, a reflective layer (Ag) (24′ in FIG. 1) of 20 nm in film thickness is formed on the second visible information recording layer by the DC sputtering method in an Ar atmosphere.

### [11] Formation of a Second UV Adhesive Layer

Next, a UV curable resin (SD640; manufactured by Dainippon Ink & Chemicals, Inc.) is coated on the second reflective layer by a spin coating method, and the coated film is irradiated with UV rays to cure. Thus, a 20-μm thick second UV adhesive layer is formed.

### [12] Formation of a Third Visible Information Recording Layer

Next, in order to form a third visible information recording layer, a coating solution for forming the third visible information recording layer is prepared by dissolving 1.5 g of a dye precursor (DP1-89) capable of forming yellow color by heat and 0.5 g of a sensitizing dye (DP2-8D) capable of absorbing laser light to undergo thermal decomposition in 100 ml of 2,2,3,3-tetrafluoro-1-propanol. Then, the coating solution for forming the third visible information recording layer is coated on the second UV adhesive layer by the spin coating method to form the third visible information recording layer of 100 nm in thickness (14″ in FIG. 1).

### [13] Formation of a Third Reflective Layer

Next, a reflective layer (Ag) (24″ in FIG. 1) of 60 nm in film thickness is formed on the third visible information recording layer by a DC sputtering method in an Ar atmosphere.

### [14] Formation of a Second Protective Layer

Next, a UV curable resin (SD318; manufactured by Dainippon Ink & Chemical Industries, Inc.) is coated on the third reflective layer by spin coating method, and then the coated layer is irradiated with UV rays to cure, thus a second protective layer of 10μ in thickness being prepared. A second disc is prepared by the above-described steps.

### [15] Lamination

Subsequently, SD640 (manufactured by Dainippon Ink & Chemicals, Inc.) is dropwise applied to the first protective layer of the first disc with the first protective layer facing upward and, after placing thereon the second disc with the second protective layer thereof facing downward, UV is irradiated from above to cure the UV ray curable resin. Thus, there is obtained an optical information recording medium in Example 1.

### [16] Recording of Visible Information

Visible information is recorded on the optical information recording medium in Example.

Upon recording, a recording apparatus having a laser pickup capable of emitting a laser light and a rotating mechanism for rotating an optical information recording medium (the laser being a semiconductor laser of 660 nm in wavelength) and, while relatively moving the optical information recording medium and the laser pickup to each other along the surface of the optical information recording medium, image information is first recorded on the first visible information recording layer by the semiconductor laser light modulated according to desired image data in synchronous with the relative movement under the condition of a linear velocity of 3.5 m/s and a recording power of 8 mW and under the state that the laser light is focused on the first visible information recording layer and, subsequently, image information is recorded on the second visible information recording layer under the state that the laser light is focused on the second information recording layer and, further, image information is recorded on the third visible information recording layer under the state that the laser light is focused on the third information recording layer. In this occasion, the laser light is oscillated in the radius direction of the optical information recording medium and, in additions irradiated plural times along about the same locus to record a visible image.

[17] Observation of the State of the Recorded Side after Recording

Also, observation of the recorded optical information recording medium reveals that colors are formed in only laser light-irradiated areas of the individual visible information recording layers, and that an intended image can be displayed in full colors.

### 7b. Comparative Example

With an optical information recording medium prepared in the same manner as in Example except for forming the visible information recording layer as one layer (i.e., omitting the steps [8] to [13] described above), only one-color (magenta color) is formed when visible information is recorded on the visible information recording layer, failing to give a full-color display.

### ADVANTAGES OF THE INVENTION

With an optical information recording medium the label side of which is to be recorded by means of a laser, it is possible to display various colors by superposing a plurality of recording layers each being capable of forming a different color, and irradiating individual layers with a laser light focused for respective layers to form color only at the laser light-irradiated areas, based on subtractive color mixing of colors formed in the recorded areas of the individual layers when viewed with the layers being superposed one over the other. Also, the degree of color formation in each layer can be varied by properly changing the irradiation time for the laser light-irradiated area to thereby change thermal energy that a dye precursor in the area receives. Thus, it is possible to prepare an optical information recording medium wherein information is recorded on the label side thereof with various hues, various degrees of lightness, and various degrees of gradation.

With an optical information recording medium the label side of which is to be recorded and wherein the recording layer contains a sensitizer capable of absorbing, upon recording, a laser light to convert the light energy to heat and a dye precursor capable of forming a dye by the heat, or contains a dye precursor capable of absorbing the wavelength of light emitted by the laser, the recorded areas can be visibly displayed in color.

Further, it is possible to visibly display various colors by superposing a plurality of recording layers each being capable of forming a different color, and irradiating individual layers with a laser light focused on respective layers to form color only at the laser light-irradiated areas, based on subtractive color mixing of colors formed in the recorded areas of the individual layers when viewed with the layers being superposed one over the other. Also, the degree of color formation in each layer can be varied by properly changing the irradiation time for the laser light-irradiated area to thereby change thermal energy that a dye precursor in the area receives. Thus, it is possible to prepare an optical information recording medium wherein information is visibly recorded on the label side thereof with various hues, various degrees of lightness, and various degrees of gradation.

As a different means, it is also possible to visibly display various colors by using at least one color-forming recording layer and at least one decolorizing recording layer, and forming color in recorded areas of one layer and reducing color in recorded areas of another layer, based on subtractive color mixing of colors in the recorded areas of the individual layers when viewed with the layers being superposed one over the other

The entire disclosure of each and every foreign patent application from which the benefit of foreign priority has been claimed in the present application is incorporated herein by reference, as if fully set forth.

What is claimed is:

1. An optical information recording medium comprising, in order:
a first substrate;
a recording layer capable of recording and reproducing information by irradiation with a first laser;
a reflective layer;
at least two visible information recording layers capable of recording visible information by irradiation with a second laser; and
a second substrate,
wherein said two visible information recording layers are not fused or mixed with each other by irradiation with said second laser light.

2. The optical information recording medium of claim 1, wherein
at least one of said visible information recording layers contains a compound capable of forming a dye by at least light or heat.

3. The optical information recording medium of claim 1, wherein
at least one of said visible information recording layers contains a compound capable of undergoing at least color reduction or decoloration by at least light or heat.

4. The optical information recording medium of claim 2, wherein said compound capable of forming the dye comprises a compound represented by the following formula (1) or formula (2):
AP¹-PDH1-AP² Formula (1)
wherein
PDH1 represents a group containing a moiety capable of causing a reaction accompanied by change in absorption upon leaving of AP¹ and AP², and each of AP¹ and AP² represents a group capable of thermally leaving, a group capable of leaving or a hydrogen atom, provided that at least one of AP¹ and AP² is a group capable of thermally leaving,
PD²-AP³ Formula (2)
wherein
PD² represents a group containing a moiety capable of causing a reaction accompanied by change in absorption upon breakage of the bond with AP³, and
AP³ represents a group capable of thermally leaving.

5. The optical information recording medium of claim 4, wherein
said compound capable of forming the dye comprises a combination of said compound represented by formula (2) and a compound represented by the following formula (3), which has no absorption in a range of from 400 nm to 850 nm: 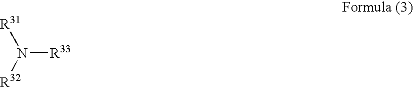
wherein
each of R³¹ and R³² represents a hydrogen atom or an aliphatic group, and
R³³ represents an aliphatic group, an aryl group, a hetero ring group, an acyl group, an aromatic oxycarbonyl group, an aliphatic sulfonyl group, an aromatic sulfonyl group, a phosphoryl group, a carbamoyl group or a sulfamoyl group,
provided that R³¹ to R³³ may be connected to each other to form a 5- to 7-membered, nitrogen-containing hetero ring.

6. The optical information recording medium of claim 2, wherein
said compound capable of forming the dye comprises a compound represented by the following formula (1-1): 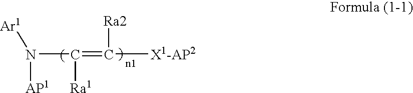
wherein
Ar¹ represents an aryl group or an aromatic hetero ring group,
X¹ represents —O— or —N(Ra³)—,
each of Ra¹, Ra², and Ra³ represents a hydrogen atom or a substituent,
n1 represents an integer of 0, 1 or 2, and
AP¹ and AP² are the same as the AP¹ and AP² of formula (1), respectively,
provided that Ar¹, Ra¹, Ra², and Ra³ may be connected to each other to form a 5- to 7-membered ring,
when n1 represents 2, each Ra¹ may be the same as or different from the other Ra¹ and each Ra² may be the same as or different from the other Ra², and
when n1 represents 0, X¹ represents —N(Ra³)—.

7. The optical information recording medium of claim 2, wherein
said compound capable of forming the dye comprises a compound represented by the following formula (2-1), (2-2) or (2-3), or a tautomer thereof: 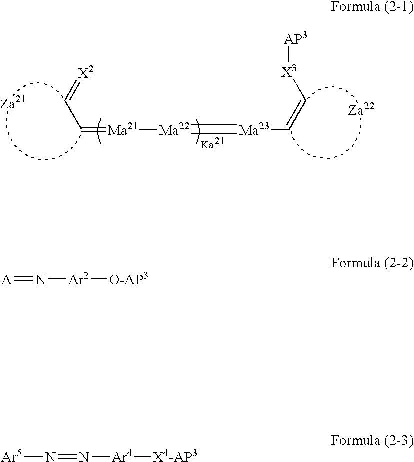
wherein
AP³ of each of formulae (2-1), (2-2) and (2-3) is the same as the AP³ of formula (2),
Za²¹ represents a group of atoms forming an acidic nucleus together with C—C═X²,
Za²² represents a group of atoms forming an acidic nucleus together with C═C—X³-AP³,
each of X² and X³ independently represents an oxygen atom, a sulfur atom or NR, provided that R represents a hydrogen atom or an alkyl group,
each of Ma²¹, Ma²² and Ma²³ independently represents a substituted or unsubstituted methine group,
Ka²¹ represents an integer of 0 to 2, provided that when Ka²¹ represents 2, each Ma²¹ may be the same as or different from the other Ma²¹ and each Ma²² may be the same as or different from the other Ma²²,
Ar² represents an axylene group,
A represents a substituted aliphatic group, a carbon ring group or a hetero ring group,
Ar⁴ represents a divalent substituted aliphatic group, a divalent carbon ring group or a divalent hetero ring group,
Ar⁵ represents an aryl group or a hetero ring group, and
X⁴ represents a single bond or an oxygen atom.

8. The optical information recording medium of claim 3, wherein
said compound capable of undergoing at least color reduction or decoloration comprises at least one dye selected from the group consisting of an oxonol dye, a cyanine dye, an azo dye, a phthalocyanine dye and a pyrromethene dye.

9. The optical information recording medium of claim 8, wherein
said oxonol dye comprises a dye represented by the following formula (2-1 D_{OX}): 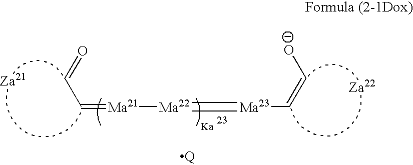
wherein
Q represents a monovalent cation necessary for neutralizing an electric charge of the dye,
Za²¹ represents a group of atoms forming an acidic nucleus together with C—C═O,
Za²² represents a group of atoms forming an acidic nucleus together with C═C—O⁻,
each of Ma²¹, Ma²² and Ma²³ independently represents a substituted or unsubstituted methine group, and
Ka²³ represents an integer of from 0 to 3,
provided that when Ka²³ represents 2 or 3, each Ma²¹ may be the same as or different from every other Ma²¹ and each Ma²² may be the same as or different from every other Ma²².

10. The optical information recording medium of claim 1, further comprising, in order:
an adhesive layer; and a second reflective layer, both being between said reflective layer and said visible information recording layers.

11. The optical information recording medium of claim 1, further comprising:
an adhesive layer between said reflective layer and said visible information recording layers.

12. The optical information recording medium of claim 1, further comprising, in order:
a protective layer; and an adhesive layer, both being between said reflective layer and said visible information recording layers.

13. The optical information recording medium of claim 1, further comprising, in order:
a first protective layer; an adhesive layer; and a second protective layer, all being between said reflective layer and said visible information recording layers.

14. The optical information recording medium of claim 1 further comprising, in order:
a first protective layer; an adhesive layer; a second protective layer; and a second reflective layer, all being between said reflective layer and said visible information recording layers.

15. The optical information recording medium of claim 1, further comprising:
at least one second reflective layer that is interleaved with the at least two visible information recording layers.
